(19) United States
(12) Patent Application Publication
(10) Pub. No.: US 2025/0232423 A1
(43) Pub. Date: Jul. 17, 2025

(54) METHOD AND APPARATUS FOR LOCATING ANOMALIES IN A PIPE

(71) Applicant: Hydromax USA, LLC, Evansville, IN (US)

(72) Inventors: David STIGER, Evansville, IN (US); Saliya KIRIGEEGANAGE, Louisville, KY (US); Adam Fredrick STEWART, Louisville, KY (US); Jacob W. BERG, Vine Grove, KY (US)

(73) Assignee: Hydromax USA, LLC, Evansville, IN (US)

(21) Appl. No.: 18/669,890

(22) Filed: May 21, 2024

Related U.S. Application Data
(60) Provisional application No. 63/620,957, filed on Jan. 15, 2024.

(51) Int. Cl. G06T 7/00; F16L 55/26; F16L 101/30; H04N 7/18; H04N 19/40

(52) U.S. Cl. CPC G06T 7/0002; F16L 55/26; H04N 7/183; F16L 2101/30; G06T 2200/24; G06T 2207/10016; G06T 2207/20081; G06T 2207/30168; H04N 19/40

(57) ABSTRACT

A method for automatically detecting at least one anomaly inside of a conduit. The method includes steps of: moving an optical imaging device of a system inside of the conduit; viewing at least one anomaly inside of the conduit with the optical imaging device; outputting a video stream by the optical imaging device with the at least one anomaly to a user interface of the system; executing an anomaly detection program, by a controller of the system, from a computer readable medium in response to the at least one anomaly being viewed by the optical imaging device, wherein the controller is caused to: automatically detect the at least one anomaly with a machine learning protocol of the anomaly detection program; and apply an alert to the at least one anomaly on the video stream.

### REFERENCE TO RELATED APPLICATIONS

This application claims the benefit of U.S. Provisional Application Ser. No. 63/620,957, filed on Jan. 15, 2024; the disclosure of which is incorporated herein by reference.

### TECHNICAL FIELD

This disclosure is directed to a conduit anomaly detection system for autonomously detecting one or more types of conduit anomalies.

### BACKGROUND ART

Wastewater and sewage conduits are commonly inspected by trained operator and technicians for various structural reasons. In one instance, wastewater or sewage conduit inspections may be routine to visually confirm that such conduit is free from anomalies or structural issues that may risk the structural integrity and drainage capabilities of the conduit. Such anomalies or structural issues that may be found in these conduits include, but are not limited to, fissures, cracks, roots, cross-bores, or other similar anomalies or structural issues that may risk the structural integrity and drainage capabilities of the conduit.

To combat this issue, camera inspection services are used to analyze these wastewater and sewer conduits at various depths for a thorough inspection. However, such inspection are being performed manually in real-time while the camera is being fed through conduit. By manually reviewing these conduits, operators and technicians must spend a vast amount of time when viewing video streams to ensure that each conduit anomaly is noted which, inevitably, increases labor time and costs of inspecting a wastewater conduit. Moreover, such manual review performed by these operators and technicians may also include human errors when searching for conduit anomalies captured on the video stream. In some instances, operators and technicians may miss or fail to see one or more anomalies in the conduit due to various reasons, including the visibility inside of the conduit, the size or shape of the anomaly, or other reasons of the like.

Furthermore, the operation of locating and recording exact locations of anomalies or structural issues lacks specificity. In conventional operations, a travel distance of a camera or controlled inspection vehicle (that records and outputs a video stream from inside of the conduit) may be measured from a desired starting point to the end of the conduit. While such measurement is useful, this measurement only provides a single set of data points or measurements when locating detected anomalies inside of the conduit. As such, locating such anomalies when the conduit is not visible to the inspectors or technicians (e.g., below a ground surface, concealed by a structure, etc.) becomes difficult unless these inspectors or technicians know the route and/or path of the conduit.

### SUMMARY OF THE INVENTION

In one aspect, an exemplary embodiment of the present disclosure may provide a method for automatically detecting at least one anomaly inside of a conduit. The method includes steps of: moving an optical imaging device of a system inside of the conduit; viewing at least one anomaly inside of the conduit with the optical imaging device; outputting a video stream by the optical imaging device with the at least one anomaly to a user interface of the system; executing an anomaly detection program, by a controller of the system, from a computer readable medium in response to the at least one anomaly being viewed by the optical imaging device, wherein the controller is caused to: automatically detect the at least one anomaly with a machine learning protocol of the anomaly detection program; and apply an alert to the at least one anomaly on the video stream.

This exemplary embodiment or another exemplary embodiment further includes that the step of executing an anomaly detection program by the controller further comprises: outputting the video stream to an application program interface; transcoding the video stream, by a video transcoding process of the anomaly detection program, from a first video format to a second video format; and outputting the video stream having the second video format to the machine learning protocol. This exemplary embodiment or another exemplary embodiment further includes that the step of automatically detect the at least one anomaly from the machine learning protocol further comprises: judging the second video format of the video stream by a video quality analyzer of the machine learning protocol. This exemplary embodiment or another exemplary embodiment further includes that the step of automatically detect the at least one anomaly from the machine learning protocol further comprises: determining a type of anomaly of the at least one anomaly by a conduit assessor of the machine learning protocol; wherein the conduit assessor is loaded with pipe, lateral, and manhole assessment coding guidelines. This exemplary embodiment or another exemplary embodiment further includes that the step of automatically detect the at least one anomaly from the machine learning protocol further comprises: determining the at least one anomaly is a cross-bore defined in the conduit by a cross-bore analyzer of the machine learning protocol. This exemplary embodiment or another exemplary embodiment further includes that the step of executing the anomaly detection program by the controller further comprises: storing the video stream having the first format in a first storage component of the video transcoding process; transcoding the video stream from the first format to a second format by a video transcoder; and storing the video stream having the second format in a second storage component of the video transcoding process. This exemplary embodiment or another exemplary embodiment further includes that the step of executing the anomaly detection program by the controller further comprises: outputting the video stream with the second format to a transcode information component; and outputting the video stream to a database of the anomaly detection program. This exemplary embodiment or another exemplary embodiment further includes that the step of executing the anomaly detection program by the controller further comprises: outputting the video stream with the second format to the machine learning protocol. This exemplary embodiment or another exemplary embodiment further includes steps of outputting the database to the machine learning protocol; and training the machine learning protocol with the database. This exemplary embodiment or another exemplary embodiment further includes that the step of outputting a report of the at least one anomaly detected by the system.

In another aspect, another exemplary embodiment of the present disclosure may provide a system for automatically detecting at least one anomaly inside of a conduit, comprising: an optical imaging device; a controller operatively in communication with the optical imaging device; a global positioning system (GPS) operably engaged with the optical imaging device and is operatively in communication with the controller; and an anomaly detection program stored on a computer readable medium that is executable by the controller; wherein when the controller executes the anomaly detection program, the controller is instructed to automatically detect the at least one anomaly inside of the conduit and is instructed to record a location of the at least one anomaly with the GPS in response to the optical imaging device viewing the at least one anomaly inside of the conduit.

This exemplary embodiment or another exemplary embodiment further includes that the anomaly detection program further comprises: an application program interface; a video transcoding architecture operatively in communication with the application program interface; and a machine learning protocol operatively in communication with the application program interface and the video transcoding architecture. This exemplary embodiment or another exemplary embodiment further includes that the machine learning protocol comprises: a video quality analyzer operatively in communication with the video transcoding architecture. This exemplary embodiment or another exemplary embodiment further includes that the machine learning protocol further comprises: a conduit assessor operatively in communication with the video transcoding architecture and configured with pipe, lateral, and manhole assessment coding guidelines. This exemplary embodiment or another exemplary embodiment further includes that the machine learning protocol further comprises: a cross-bore analyzer operatively in communication with the video transcoding architecture and configured with cross-bore assessment guidelines. This exemplary embodiment or another exemplary embodiment further includes that the video transcoding architecture comprises: a first storage component operatively in communication with the application program interface; a video transcoder operatively in communication with the first storage component; a second storage component operatively in communication with the first storage component and the machine learning protocol; and a video transcoding service operatively in communication with the second storage component. This exemplary embodiment or another exemplary embodiment further includes that the anomaly detection program further comprises: a video database operatively in communication with the video transcoding architecture and the machine learning protocol.

In yet another aspect, another exemplary embodiment of the present disclosure may provide a computer program product stored on a computer readable media and executable by a controller of a system for automatically detecting at least one anomaly inside of a conduit: executing, by the controller, a first step to automatically detect the at least one anomaly with a machine learning protocol of an anomaly detection program in response to the at least one anomaly being viewed on a video stream outputted by an optical imaging device of the system; and executing, by the controller, a second step to automatically apply an alert to the at least one anomaly on the video stream.

This exemplary embodiment or another exemplary embodiment further includes steps of executing, by the controller, a third step to output the video stream to an application program interface; executing, by the controller, a fourth step to transcode the video stream, by a video transcoding process of the anomaly detection program, from a first video format to a second video format; and executing, by the controller, a fifth step to output the video stream having the second video format to the machine learning protocol. This exemplary embodiment or another exemplary embodiment further includes that the step of executing the first step by the controller further comprises: executing, by the controller, a third step to judge the second video format of the video stream by a video quality analyzer of the machine learning protocol; executing, by the controller, a fourth step to determine a type of anomaly of the at least one anomaly by a conduit assessor of the machine learning protocol, wherein the conduit assessor is loaded with pipe, lateral, and manhole assessment coding guidelines; and executing, by the controller, a fifth step to determine the at least one anomaly is a cross-bore defined in the conduit by a cross-bore analyzer of the machine learning protocol.

In yet another aspect, another exemplary embodiment of the present disclosure may provide a method for automatically detecting at least one anomaly inside of a conduit in real-time computing. The method includes steps of: moving an optical imaging device of a system inside of the conduit; viewing at least one anomaly inside of the conduit with the optical imaging device in real-time; outputting a live video stream by the optical imaging device with the at least one anomaly to a control interface of the system; executing an anomaly detection program, by a controller of the system, from a computer readable medium in response to the at least one anomaly being viewed by the optical imaging device from the live video stream, wherein the controller is caused to: automatically detect the at least one anomaly with a machine learning protocol of the anomaly detection program; output the at least one detected anomaly to the control interface; and automatically indicate the at least one detected anomaly on the live video stream.

This exemplary embodiment or another exemplary embodiment further includes that the step of automatically detecting the at least one anomaly from the machine learning protocol further comprises: judging a video format of the video stream by a video quality analyzer of the machine learning protocol. This exemplary embodiment or another exemplary embodiment further includes that the step of automatically detecting the at least one anomaly from the machine learning protocol further comprises: determining a type of anomaly of the at least one anomaly by a conduit assessor of the machine learning protocol; wherein the conduit assessor is loaded with pipe, lateral, and manhole assessment coding guidelines. This exemplary embodiment or another exemplary embodiment further includes that the step of automatically detecting the at least one anomaly from the machine learning protocol further comprises: determining the at least one anomaly is a cross-bore defined in the conduit by a cross-bore analyzer of the machine learning protocol. This exemplary embodiment or another exemplary embodiment further includes a step of intercepting the video stream, by a video interceptor, between the optical imaging device and the control interface. This exemplary embodiment or another exemplary embodiment further includes that the step of intercepting the video stream further comprises: outputting the video stream, by the video interceptor, to the controller; outputting the video stream, by the controller, to a dedicated monitor separate from the control interface; and indicating the at least one detected anomaly on the dedicated monitor separate from the control interface. This exemplary embodiment or another exemplary embodiment further includes a step of updating the machine learning protocol of the anomaly detection program by a cloud-based repository. This exemplary embodiment or another exemplary embodiment further includes a step of updating the machine learning protocol of the anomaly detection program by a universal serial bus (USB) repository component. This exemplary embodiment or another exemplary embodiment further includes that the step of indicating the at least one detected anomaly on the live video stream further includes an alert system that is accessible by the controller.

In yet another aspect, another exemplary embodiment of the present disclosure may provide a system for automatically detecting at least one anomaly inside of a conduit in real-time computing. The system includes an optical imaging device outputting a live video stream; a controller operatively in communication with the optical imaging device; a control interface operatively in communication with the optical imaging device and the controller; an anomaly detection program having a machine learning protocol and is stored on a computer readable medium that is executable by the controller; wherein when the controller executes the machine learning protocol of the anomaly detection program, the controller is instructed to automatically detect the at least one anomaly inside of the conduit in response to the optical imaging device when viewing the at least one anomaly inside of the conduit from the live video stream.

This exemplary embodiment or another exemplary embodiment further includes that the machine learning protocol comprises: a video quality analyzer operatively in communication with a video transcoding architecture of the anomaly detection program. This exemplary embodiment or another exemplary embodiment further includes that the machine learning protocol further comprises: a conduit assessor operatively in communication with a video transcoding architecture of the anomaly detection program and configured with pipe, lateral, and manhole assessment coding guidelines. This exemplary embodiment or another exemplary embodiment further includes that the machine learning protocol further comprises: a cross-bore analyzer operatively in communication with a video transcoding architecture of the anomaly detection program and configured with cross-bore assessment guidelines. This exemplary embodiment or another exemplary embodiment further includes a video interceptor operatively in communication with the optical imaging device and the control interface and configured to output the live video stream to the controller. This exemplary embodiment or another exemplary embodiment further includes a dedicated monitor operatively in communication with the controller and configured to indicate the at least one detected anomaly. This exemplary embodiment or another exemplary embodiment further includes a cloud-based repository component operatively in communication with the controller and configured to provide at least one update for the machine learning protocol. This exemplary embodiment or another exemplary embodiment further includes a universal serial bus (USB) repository component operatively in communication with the controller and configured to provide at least one update for the machine learning protocol. This exemplary embodiment or another exemplary embodiment further includes an alert system that is accessible by the controller for applying alerts on the at least one anomaly detected.

In yet another aspect, another exemplary embodiment of the present disclosure may provide a computer program product stored on a computer readable media and executable by a controller of a system for automatically detecting at least one anomaly inside of a conduit in real-time computing: executing, by the controller, a first step to automatically detect the at least one anomaly with a machine learning protocol of an anomaly detection program in response to the at least one anomaly being viewed by on a live video stream recorded by an optical imaging device of the system; executing, by the controller, a second step to output the at least one detected anomaly to the control interface; and executing, by the controller, a third step to automatically indicate the at least one detected anomaly on the live video stream.

This exemplary embodiment or another exemplary embodiment further includes that the step of executing by the controller the first step to automatically detect the at least one anomaly with the machine learning protocol further comprising: executing, by the controller, a fourth step to judge the live video stream by a video quality analyzer of the machine learning protocol; executing, by the controller, a fifth step to determine a type of anomaly of the at least one anomaly by a conduit assessor of the machine learning protocol, wherein the conduit assessor is loaded with pipe, lateral, and manhole assessment coding guidelines; and executing, by the controller, a sixth step to determine the at least one anomaly is a cross-bore defined in the conduit by a cross-bore analyzer of the machine learning protocol.

In yet another aspect, another exemplary embodiment of the present disclosure may provide a method for locating at least one anomaly inside of a conduit in real-time computing. The method includes steps of: moving a controlled inspection vehicle of a system, by a controller, inside of the conduit at a starting point; viewing at least one anomaly inside of the conduit at a point of interest (POI) with the controlled inspection vehicle; emitting a detection signal, by the controlled inspection vehicle, at the POI; finding the detection signal by a locator that is remote of the conduit; and recording the detection signal of the POI with the locator.

This exemplary embodiment or another exemplary embodiment further includes that the step of recording the POI with the locator further comprises: measuring a depth between the locator and the POI, wherein the depth correlates to the depth of the at least one anomaly relative to a ground surface. This exemplary embodiment or another exemplary embodiment further includes that the step of recording the POI with the locator further comprises: recording a longitudinal distance between the starting point and the POI, wherein the longitudinal distance correlates to the distance of the at least one anomaly relative to the starting point. This exemplary embodiment or another exemplary embodiment further includes that the step of recording the POI with the locator further comprises: recording a lateral distance between a known structure proximate to the conduit and the POI, wherein the lateral distance correlates to the distance of the at least one anomaly relative to the known structure. This exemplary embodiment or another exemplary embodiment further includes step of recording a first data point of the POI by the controller; and denoting the first data point with an identification code. This exemplary embodiment or another exemplary embodiment further includes steps of outputting the identification code, by the controller, to the locator; receiving the identification code, by the locator, from the controller; and recording a second data point of the POI with the identification code by the locator. This exemplary embodiment or another exemplary embodiment further includes steps of combining the first data point and the second data point with one another; and generating a single geolocated point of the POI. This exemplary embodiment or another exemplary embodiment further includes a step of calibrating the controlled inspection vehicle to the starting point. This exemplary embodiment or another exemplary embodiment further includes steps of inputting at least one reference point from a preexisting location; and measuring a distance between the POI and the at least one reference point of the preexisting location; wherein the reference point is a known location. This exemplary embodiment or another exemplary embodiment further includes steps of viewing the at least one anomaly inside of the conduit at a second POI with the controlled inspection vehicle; emitting a second detection signal, by the controlled inspection vehicle, at the second POI; receiving the second detection signal by the locator that is remote of the conduit; and recording the second detection signal of the second POI with the locator. This exemplary embodiment or another exemplary embodiment further includes steps of averaging the POI and the second POI with one another; and outputting an averaged POI for the at least one anomaly.

In yet another aspect, another exemplary embodiment of the present disclosure may provide a computer program product stored on a computer readable media and executable by a controller and a locator of a system for locating at least one anomaly inside of a conduit in real-time computing: executing, by the controller, a first step to instruct a controlled inspection vehicle to move inside of the conduit at a starting point; executing, by the controller, a second step to instruct the controlled inspection vehicle to emit a detection signal in response to viewing the at least one anomaly inside of the conduit at a point of interest (POI); executing, by the locator, a third step to find the detection signal by a locator that is outside of the conduit; and executing, by the locator, a fourth step to record the detection signal of the POI.

This exemplary embodiment or another exemplary embodiment further includes a step of executing, by the locator, a fifth step to record a depth between the locator and the POI, wherein the depth correlates to the depth of the at least one anomaly relative to a ground surface. This exemplary embodiment or another exemplary embodiment further includes a step of executing, by the locator, a fifth step to record a longitudinal distance between the starting point and the POI, wherein the longitudinal distance correlates to the distance of the at least one anomaly relative to the starting point. This exemplary embodiment or another exemplary embodiment further includes a step of executing, by the locator, a fifth to record a lateral distance between a known structure proximate to the conduit and the POI, wherein the lateral distance correlates to the distance of the at least one anomaly relative to the known structure. This exemplary embodiment or another exemplary embodiment further includes steps of executing, by the controller, a fifth step to record a first data point of the POI by the controller; and executing, by the controller, a sixth step to denote the first data point with an identification code. This exemplary embodiment or another exemplary embodiment further includes steps of executing, by the controller, a seventh step to output the identification code to the locator; and executing, by the locator, an eighth step to record a second data point of the POI with the identification code by the locator in response to receiving the identification code from the controller. This exemplary embodiment or another exemplary embodiment further includes steps of executing, by a processor, a ninth step to combine the first data point and the second data point with one another; and executing, by a processor, a tenth step to generate a single geolocated point of the POI. This exemplary embodiment or another exemplary embodiment further includes a step of executing a fifth step, by the controller, to calibrate the controlled inspection vehicle to the starting point.

In yet another aspect, another exemplary embodiment of the present disclosure may provide a system for automatically recording at least one anomaly inside of a conduit, comprising: a controlled detection vehicle; a controller operatively in communication with the controlled detection vehicle; a locator operatively in communication with the controller detection vehicle and the controller; and an anomaly location program stored on a computer readable medium that is executable by the controller; wherein when the controller executes the anomaly location program, the controller instructs the controlled detection vehicle to output at least one detection signal inside of the conduit in response to the controller viewing the at least one anomaly inside of the conduit via the controlled detection vehicle.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a diagrammatic view of a wastewater detection system in accordance with one aspect of the present disclosure.

FIG. 2 is an exemplary flowchart of an anomaly detection program of the wastewater detection system shown in FIG. 1.

FIG. 3A is an operational view of an optical imaging device being moved through the conduit shown in FIG. 1.

FIG. 3B is another operational view continuing from FIG. 3A, but the view is taken from a video stream captured by the optical imaging device.

FIG. 3C is another operational view similar to FIG. 3A, but the optical imaging device views and approaches at least one anomaly positioned in the conduit.

FIG. 3D is another operational view continuing from FIG. 3C, but the view is taken from the video stream captured by the optical imaging device.

FIG. 3E is another operation view similar to FIG. 3C, but the wastewater detection system emits a location signal once the anomaly is detected for global positioning operations.

FIG. 3F is another operational view continuing from FIG. 3E, but the view is taken from the video stream captured by the optical imaging device, wherein the controller detects and highlights the anomaly when executing the anomaly detection program.

FIG. 3G is another operational view continuing from FIG. 3F, wherein the location signal emitted by the GPS is mapped on a report generated by a processing unit operatively in communication with the wastewater detection system.

FIG. 4 is a diagrammatic view of a second wastewater detection system in accordance with another aspect of the present disclosure.

FIG. 5 is an exemplary flowchart of a second anomaly detection program of the wastewater detection system shown in FIG. 4.

FIG. 6 is an exemplary flowchart of a third anomaly detection program of the wastewater detection system shown in FIG. 4.

FIG. 7 is a diagrammatic view of a third wastewater detection system in accordance with yet another aspect of the present disclosure.

FIG. 8 is an exemplary flowchart of an anomaly location program of the third wastewater detection system shown in FIG. 7.

FIG. 9A is an operational view of a controlled inspection vehicle being moved through the conduit shown in FIG. 7.

FIG. 9B is another operational view continuing from FIG. 9A, wherein a transmitter of the controlled inspection vehicle views an anomaly inside of the conduit and emits a location signal.

FIG. 9C is another operational view continuing from FIG. 9B, wherein a locator of the system receives and records the location signal emitted by the transmitter of the controlled inspection vehicle.

FIG. 9D is another operational view continuing from FIG. 9C, wherein a controller of the system records a first data point of the anomaly with an associated identification code, wherein the identification code is outputted to the locator.

FIG. 9E is another operational view continuing from FIG. 9D, wherein the locator of the system records a second data point of the anomaly with the identification code.

FIG. 9F is another operational view continuing from FIG. 9E, wherein the location signal recorded by the controller and locator is mapped on a report generated by a processing unit operatively in communication with the system.

Similar numbers refer to similar parts throughout the drawings.

### DETAILED DESCRIPTION

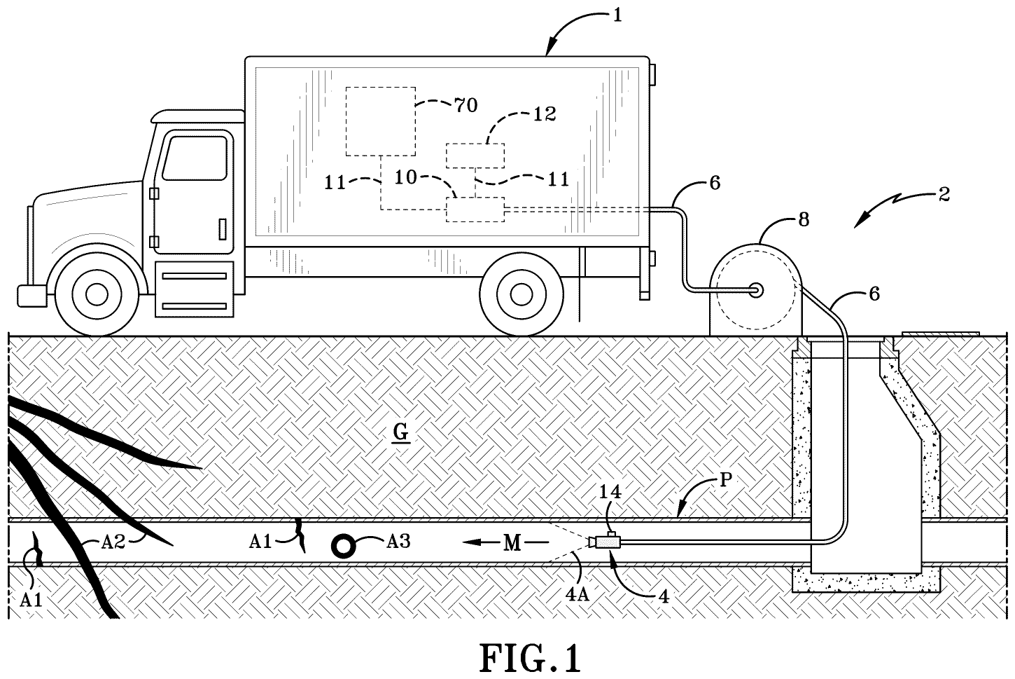

FIG. 1 illustrates a control center 1 that is configured with a wastewater inspecting system or wastewater anomaly detection system (hereinafter “system”) generally referred to as 2. In the present disclosure, the control center 1 and the system 2 are configured to operate with one another such that the system 2 outputs information detected inside of the wastewater conduit when examining and/or inspecting the wastewater conduit. As discussed in greater detail below, system 2 is configured to automatically detect and indicate one or more anomalies found or defined in a wastewater or sewage conduit upon inspecting said wastewater or sewage conduit free from operator involvement. Such components of the system 2 are discussed in greater detail below.

It should be understood that control center 1 may be any suitable machine or structure that is configured to communicate and to be operably with the system 2. In one exemplary embodiment, a control center mentioned herein may be a moveable or mobile vehicle, such as an automobile or similar motorized vehicle, that is configured to communicate and to be operable with a system mentioned herein. In another exemplary embodiment, a control center mentioned herein may be a non-moveable structure that is configured to communicate and to be operable with a system mentioned herein. In one exemplary embodiment, a control center mentioned herein may be a mobile electronic machine, such as a smartphone, tablet, computer, or similar mobile electronic machine, that is configured to communicate and to be operable with a system mentioned herein. In another exemplary embodiment, a control center mentioned herein may be portable apparatus or push camera system that includes a viewing display, a reel for carrying cables and an optical imaging device of a system, and other devise and/or components for running an anomaly detection program discussed herein.

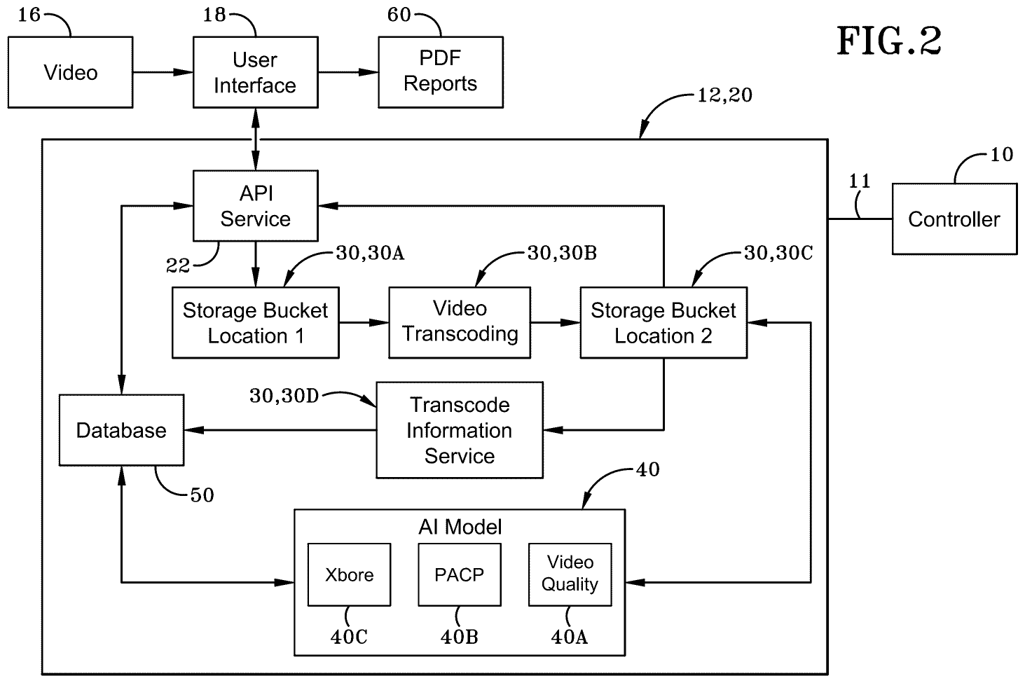

With respect to the system 2, system 2 includes an optical imaging device 4 that operatively connects with the control center 1 by a cable 6. As best seen in FIG. 2, the optical imaging device 4 is configured to be placed into and traverse through a wastewater or sewer conduit to view the inner walls and/or surfaces for conduit anomalies or irregularities at a viewing angle 4A; such viewing of the inner walls and/or surfaces for conduit anomalies or irregularities is discussed in greater detail below. In operation, the optical imaging device 4 records and outputs a video stream as the optical imaging device 4 traverse through the wastewater conduit. The optical imaging device 4 may also continuously output the video stream to the control center 1 via the cable 6 connecting the control center 1 and the optical imaging device 4 with one another. The system 2 may also include a reel or similar carrying device 8 for carrying and housing the cable 6 during operation.

In the present disclosure, the optical imaging device 4 is a video recording camera that is configured to record video while being located in wastewater or sewer conduits and output such video information to the control center 1 by the cable 6. It should be understood that any suitable device, commercially-available or commercially-unavailable, may be used herein for recording video while being located in wastewater or sewer conduits. It should also be understood that while the optical imaging device 4 outputs recorded video information to the control center 1 by the cable 6, any suitable electrical connection may be used to output or transfer recorded video information to a control center mentioned herein. In one exemplary embodiment, an optical imaging device mentioned herein may output or transfer recorded video information to a control center via a wireless electrical connection or system that is commercially-available or commercially-unavailable as of the filing date of this disclosure.

System 2 also includes at least one controller or processing unit 10. In the present disclosure, a single controller 10 is illustrated herein for schematic and diagrammatic purposes. In other exemplary embodiments, any suitable number of processors may be provided with a system mentioned herein for a specific inspection operation (e.g., inspecting wastewater or sewage conduits). Controller 10 is configured to logically perform protocols and/or methods that the controller 10 has access to prior to inspection operation, including detection and/or examination protocols and methods. The controller 10 may also be powered by an on-board power source and/or power supply (e.g., portable battery, etc.) in order to logically perform protocols and/or methods that are operatively in communication with the controller 10. The controller 10 may also be in logical communication with a tangible medium, such as a computer readable medium, for executing conventional guidance applications or protocols and/or novel guidance applications or protocols discussed herein.

As best seen in FIGS. 1 and 2, controller 10 of system 2 may be located with control center 1. Still referring to FIG. 1, controller 10 is in electrical communication with the optical imaging device 4 via the cable 6. In the present disclosure, controller 10 is configured to receive and use video data outputted from the optical imaging device (e.g., raw video footage, digitized video footage, and other video data or information), via the cable 6, when executing an anomaly detection protocol for assisting an operator when inspecting a wastewater conduit. It should be appreciated that any suitable and/or commercially-available processor or processing unit may be used for controller 10 described and illustrated herein.

System 2 also includes a computer readable medium or media 12. As best seen in FIG. 1, system 2 includes a computer readable medium 12 that may be located with the control center 1. Referring to FIGS. 1-2, computer readable medium 12 is in electrical communication with the controller 10 via an electrical connection 11. In the present disclosure, computer readable medium 12 is pre-loaded with an anomaly detection program 20 that is accessible and executable by the controller 10. When the controller 10 executes the anomaly detection program 20 upon, the controller 10 automatically detects conduit anomalies or structural issues of the wastewater conduit that are shown in the video stream outputted by the optical imaging device 4. Such functions and/or steps provided in anomaly detection program 20 are discussed in greater detail below.

It should be understood that electrical connection 11 may be any suitable electrical connection or medium that provides electrical communication and/or logical communication between the controller 10 and the computer readable medium 12. In the present disclosure, electrical connection 11 is an electrical wire or cable that electrically connects the controller 10 and the computer readable medium 12 with one another so that the controller 10 may access and execute anomaly detection program 20 during a wastewater conduit inspection. In one exemplary embodiment, electrical connection 11 may be an available wireless connection that electrically connects the controller 10 and the computer readable medium 12 with one another so that the controller 10 may access and execute anomaly detection program 20 during a wastewater conduit inspection.

In the present disclosure, computer readable medium 12 may also be powered by an on-board power source and/or power supply (e.g., portable battery, etc.) in order to communicate with controller 10 so that controller 10 may access and execute anomaly detection program 20 during wastewater conduit inspection.

System 2 may also include a signal emitter 14. As best seen in FIG. 1, signal emitter 14 may be operably engaged with the optical imaging device 4 and is configured to be placed into and traverse through a wastewater or sewer conduit. The signal emitter 14 may also be operatively in communication with the controller 10 when the optical imaging device 4 and the signal emitter 14 are positioned inside of a wastewater conduit remote from the controller 10. In operation, and as discussed in greater detail below, signal emitter 14 may be configured to output at least one location pulse when the controller 10 detects and indicates at least one wastewater conduit anomaly found in the video stream outputted by the optical imaging device 4. Such inclusion of the signal emitter 14 allows a device of the system 2 that is above ground and outside of the wastewater conduit to automatically map and/or plot each conduit anomaly detected by the controller 10 in the video stream outputted by the optical imaging device 4.

It should be understood that while signal emitter 14 is shown with optical imaging device 4, signal emitter 14 is an optional component and may be omitted from system 2. As such, optical imaging device 4 may be inserted and maneuvered through the conduit so that the controller 10 may only automatically detect and indicate one or more anomalies while a conventional means for measuring the location of the optical imaging device 4 is outputted to controller 10 (e.g., a sensor or device that monitors the length of the cable 6 as the optical imaging device 4 moves through the conduit). It should also be understood that signal emitter 14 may also be a standalone device that is configured to automatically record the location of each anomaly found in a wastewater conduit through uses of global positioning systems currently available at the time of filing this disclosure as well as global positioning systems that are not currently available at the time of filing.

System 2 may also include a video stream 16 that is outputted by optical imaging device 4 (diagrammatically shown by a box in FIG. 2). In the present disclosure, the video stream 16 is raw and/or unedited video that is captured and outputted by the optical imaging device 4 when traversing through a wastewater conduit. As discussed in greater detail below, the video stream 16 may capture one or more anomalies found in the wastewater conduit that will be processed and detected by the anomaly detection program 20 of system 2.

System 2 may also include a user interface (UI) 18 (diagrammatically shown by a box in FIG. 2) that is operatively in communication with the optical imaging device 4. As best seen in FIG. 2, UI 18 is configured to receive and view the video stream 16 that is captured and outputted by the optical imaging device 4. In operation, UI 18 may be accessible by an operator or programmer of system 2 when the anomaly detection program 20 of system 2 processes and detects one or more anomalies found in the wastewater conduit. In addition, UI 18 may also provide a web portal or customer interface that allows users to access customer data management and processing that is specific to a desired project that is link to system 2.

As discussed earlier, system 2 also includes anomaly detection program 20. As best seen in FIG. 2, anomaly detection program 20 is stored on the computer readable medium 12 and is accessible by the controller 10 when system 2 in initiated. In operation, the anomaly detection program 20 commands the controller 10 (and other devices operatively in communication with the controller 10) to automatically detect and indicate anomalies located in the wastewater conduit based on the video stream 16 outputted by the optical imaging device 4. Such components and steps provided in the video stream outputted by the optical imaging device 4 are discussed in greater detail below.

Anomaly detection program 20 may include an application program interface (API) 22 (diagrammatically shown by a box in FIG. 2). As best seen in FIG. 2, API 22 is operatively in communication with the UI 18 to receive the video stream 16 and additional video data or information from the UI 18. In the present disclosure, UI 18 and API 22 are configured to either receive information or to send information to allow two-way communication; such two-way communication is denoted by double arrows pointing to the UI 18 and the API 22. It should be understood that API 22 may be configured to receive information from components and/or applications provided in the anomaly detection program 20 as well as send information from the components and/or applications provided in the anomaly detection program 20, which are discussed in greater detail below.

Anomaly detection program 20 may also include a video transcoding architecture 30. As best seen in FIG. 2, the video transcoding architecture 30 is operatively in communication with API 22 for receiving information from the API 22 as well as outputting information to the API 22. As discussed in greater detail below, the video transcoding architecture 30 transforms the video stream 16 from a first format or raw format to a second format or digitized format to include alerts and/or markers on the video stream 16 for anomalies detected by a machine learning protocol of anomaly detection program 20.

Still referring to FIG. 2, video transcoding architecture 30 includes a first storage bucket or storage component 30A. As best seen in FIG. 2, the first storage component 30A is diagrammatically shown as a box labeled 30A and is operatively in communication with API 22. Particularly, the first storage component 30A is configured to receive video information from API 22 (such as video stream 16) due to one-way communication; such one-way communication between API 22 and the first storage component 30A is denoted by a single arrow pointing from API 22 to the first storage component 30A. In operation, the first storage component 30A is configured to receive and store the video stream 16 from the API 22 for video transcoding, which is discussed in greater detail below. It should be understood that first storage component 30A may be any suitable storage component, commercially-available or commercially-unavailable at the filing of this disclosure, for receiving and storing the video stream 16 from the API 22 for video transcoding.

Still referring to FIG. 2, video transcoding architecture 30 also includes a video transcoder 30B. As best seen in FIG. 2, the video transcoder 30B is diagrammatically shown as a box labeled 30B and is operatively in communication with first storage component 30A. Particularly, the video transcoder 30B is configured to receive video information from first storage component 30A (such as video stream 16) due to one-way communication; such one-way communication between the first storage component 30A and the video transcoder 30B is denoted by a single arrow pointing from the first storage component 30A to the video transcoder 30B. In operation, the video transcoder 30B is configured to convert and/or format the video stream 16 from the first format (e.g., raw video captured by optical imaging device 4) to the second format or digitized format so alerts and/or markers can be applied on the video stream 16 for anomalies detected by a machine learning protocol of anomaly detection program 20. It should be understood that video transcoder 30B may be any suitable video transcoder, commercially-available or commercially-unavailable at the filing of this disclosure, for converting and/or formatting the video stream 16 from the first format (e.g., raw video captured by optical imaging device 4) to the second format or digitized format.

Still referring to FIG. 2, video transcoding architecture 30 includes a second storage bucket or storage component 30C. As best seen in FIG. 2, the second storage component 30C is diagrammatically shown as a box labeled 30C and is operatively in communication with video transcoder 30B. Particularly, the second storage component 30C is configured to receive video information from video transcoder 30B due to one-way communication; such one-way communication between video transcoder 30B and the second storage component 30C is denoted by a single arrow pointing from video transcoder 30B to the second storage component 30C. In operation, the second storage component 30B is configured to receive and store the formatted video stream from the video transcoder 30B. It should be understood that second storage component 30C may be any suitable storage component, commercially-available or commercially-unavailable at the filing of this disclosure, for receiving and storing the formatted video stream 16 from the video transcoder 30B.

In the present disclosure, the second storage component 30C is also operatively in communication with API 22. As best seen in FIG. 2, the second storage component 30C is configured to output the formatted video stream to API 22 based on one-way communication; such one-way communication between API 22 and second storage component 30C is denoted by a single arrow pointing from the second storage component 30C to API 22. Such use of outputting information back to API 22 is discussed in greater detail below.

Still referring to FIG. 2, video transcoding architecture 30 includes a transcode information component or service 30D. As best seen in FIG. 2, the transcode information component 30D is diagrammatically shown as a box labeled 30D and is operatively in communication with second storage component 30C. Particularly, the transcode information component 30D is configured to receive the formatted video stream from the second storage component 30C due to one-way communication; such one-way communication between the second storage component 30C and transcode information component 30D is denoted by a single arrow pointing from second storage component 30C to the transcode information component 30D. Transcode information component 30D is configured to set each video in a preferred and/or desired format for modeling purposes including a desired framerate, desire resolution, desired encoding factors, and other formatting features. It should be understood that transcode information component 30D may be any suitable storage component, commercially-available or commercially-unavailable at the filing of this disclosure.

Anomaly detection program 20 may also include a machine learning protocol or artificial intelligence (AI) model 40. As best seen in FIG. 2, the machine learning protocol 40 is operatively in communication with the video transcoding architecture 30 for receiving information from the video transcoding architecture 30 as well as outputting information to the video transcoding architecture 30. As discussed in greater detail below, the machine learning protocol 40 is configured to analyze and detect conduit anomalies observed in the formatted video stream to include alerts and/or markers on the video stream for said anomalies detected by the machine learning protocol 40. Such components of the machine learning protocol 40 are discussed in greater detail below.

Machine learning protocol 40 includes a video quality analyzer 40A. As best seen in FIG. 2, the video quality analyzer 40A is diagrammatically shown as a box labeled 40A and is operatively in communication with the video transcoding architecture 30. Particularly, the video quality analyzer 40A is operatively in communication with the second storage component 30C for receiving information from the second storage component 30C and for outputting information to the second storage component 30C to allow for two-way communication; such two-way communication is denoted by a double-arrow labeled pointing at the second storage component 30C and the video quality analyzer 40A.

In operation, the video quality analyzer 40A is configured to analyze and judge the quality of the formatted video stream from the second storage component 30C. Such analysis and judgement by the video quality analyzer 40A may be based on various parameters before such video stream is output to downstream components of the machine leaning protocol 40. Particularly, the video quality analyzer 40A may analyze and judge the video quality of the video stream based on the visibility inside of the wastewater conduit (e.g., a suitable amount of light to view anomalies inside of the wastewater conduit, edge sharpness of pixel delineation the video stream, and other video qualities of the like). In one instance, the video quality analyzer 40A may accept the formatted video stream when the formatted video stream meets a predetermined quality standard set in the video quality analyzer 40A (i.e., enough light to see inside of the conduit and/or video is sharp enough). In another instance, the video quality analyzer 40A may reject the formatted video stream when the formatted video stream fails to meet the predetermined stream quality set in the video quality analyzer 40A.

Machine learning protocol 40 also includes a conduit assessor 40B. As best seen in FIG. 2, the conduit assessor 40B is diagrammatically shown as a box labeled 40B and is operatively in communication with the video transcoding architecture 30. Particularly, the conduit assessor 40B is operatively in communication with the second storage component 30C for receiving information from the second storage component 30C and for outputting information to the second storage component 30C to allow for two-way communication; such two-way communication is denoted by a double-arrow labeled pointing at the second storage component 30C and the conduit assessor 40B. While not illustrated herein, conduit assessor 40B may also be operatively in communication with the video quality analyzer 40A so that the conduit assessor 40B assesses the formatted video stream at the predetermined stream quality.

In operation, the conduit assessor 40B is loaded with existing wastewater conduit inspection protocols and programs that are conventionally used in the art so that that conduit assessor 40B may automatically inspect and assess wastewater conduits. In one instance, conduit assessor 40B is loaded with the NASSCO Pipeline Assessment Certification Program (PACP), the Lateral Assessment Certification Program (LACP), and the Manhole Assessment Certification Program (MACP) for autonomously inspecting and assessing wastewater conduits. In this instance, conduit assessor 40B inspects the wastewater conduit based on the information provided in formatted video stream from the video transcoding architecture 30. Particularly, the conduit assessor 40B observes and analyzes the structural features of wastewater conduit and compares any anomalies, when detected, with the existing protocols or programs that are pre-loaded into the conduit assessor 40B. In another instance, As discussed in greater detail below, the conduit assessor 40B may also output inspection data and information based on the type of conduit anomaly found by the conduit assessor 40B. In other exemplary embodiment, any suitable standards or coding guidelines from a governing body for assessing pipelines, laterals, manholes, and other underground or hidden wastewater conduits may be loaded into conduit assessor 40B based on the implementation of system 2, including the location, region, or country the system 2 is being used.

Machine learning protocol 40 also includes a cross-bore analyzer 40C. As best seen in FIG. 2, the cross-bore analyzer 40C is diagrammatically shown as a box labeled 40C and is operatively in communication with the video transcoding architecture 30. Particularly, the cross-bore analyzer 40C is operatively in communication with the second storage component 30C for receiving information from the second storage component 30C and for outputting information to the second storage component 30C to allow for two-way communication; such two-way communication is denoted by a double-arrow labeled pointing at the second storage component 30C and the cross-bore analyzer 40C. While not illustrated herein, cross-bore analyzer 40C may also be operatively in communication with the video quality analyzer 40A so that the cross-bore analyzer 40C assesses the formatted video stream at the predetermined stream quality.

In operation, the cross-bore analyzer 40C is loaded with existing wastewater conduit inspection protocols and programs that are conventionally used in the art for automatically or autonomously inspecting and assessing wastewater conduits for cross-bores. In one instance, cross-bore analyzer 40C is loaded with pipeline programs for autonomously inspecting and assessing wastewater conduits for cross-bores. In this instance, cross-bore analyzer 40C inspects the wastewater conduit for cross-bores based on the information provided in formatted video stream from the video transcoding architecture 30. Particularly, the cross-bore analyzer 40C observes and analyzes the structural features of wastewater conduit and compares cross-bores, when detected, with the existing protocols or programs that are pre-loaded into the cross-bore analyzer 40C. As discussed in greater detail below, the cross-bore analyzer 40C may also output inspection data and information based on the cross-bores found by the cross-bore analyzer 40C.

Machine learning protocol 40 also includes a delay adjuster 40D. As best seen in FIG. 2, the delay adjuster 40D is diagrammatically shown as a box labeled 40C and is operatively in communication with the video transcoding architecture 30. Particularly, the delay adjuster 40D is operatively in communication with the second storage component 30C for receiving information from the second storage component 30C and for outputting information to the second storage component 30C to allow for two-way communication; such two-way communication is denoted by a double-arrow labeled pointing at the second storage component 30C and the delay adjuster 40D. While not illustrated herein, delay adjuster 40D may also be operatively in communication with the video quality analyzer 40A so that the delay adjuster 40D assesses and delays the video stream at a start time interval and an end time interval when the optical imaging device 4 is outside or remote of an examined wastewater conduit.

In operation, the delay adjuster 40D is programmed with time intervals to delay any assessment by the machine learning protocol 40, particularly the conduit assessor 40B and the cross-bore analyzer 40C, when the optical imaging device 4 is outside or remote of an examined wastewater conduit. In one instance, delay adjuster 40D is loaded with a start time delay as the optical imaging device 4 is translated into the examined wastewater conduit. In this instance, delay adjuster 40D prevents and/or halts any assessment by the machine learning protocol 40, particularly the conduit assessor 40B and the cross-bore analyzer 40C, for a predetermined time interval as the optical imaging device 4 is translated into an examined wastewater conduit. Such start delay prevents inadvertent and/or accidental assessment that are taken outside of the examined wastewater conduit by the machine learning protocol 40. In another instance, delay adjuster 40D is loaded with an end time delay as the optical imaging device 4 is translated out of the examined wastewater conduit. In this instance, the delay adjuster 40D prevents and/or halts any assessment by the machine learning protocol 40, particularly the conduit assessor 40B and the cross-bore analyzer 40C, for a predetermined time interval as the optical imaging device 4 is translated out of the examined wastewater conduit. Such end delay prevents inadvertent and/or accidental assessment that are taken outside of the examined wastewater conduit by the machine learning protocol 40. It should be understood that delay adjuster 40D may also be programmed to identify non-anomalies normally found inside of wastewater conduits, including manholes, sewer grates, external structures, and trees.
INCLUDE 40D→OUT OF PIPE ANALYZER

Anomaly detection program 20 also includes a video database 50. As best seen in FIG. 2, the video database 50 is diagrammatically shown as a box labeled 50 and is operatively in communication with API 22, the video transcoding architecture 30, and the machining learning protocol 40. In a first instance, the video database 50 is configured to receive video information from transcode information component 30D due to one-way communication; such one-way communication between the transcode information component 30D and the video database 50 is denoted by a single arrow pointing from transcode information component 30D to the video database 50. In a second instance, video database 50 is also configured to receive video information from and output video information to machining learning protocol 40 due to two-way communication; such two-way communication between the transcode information component 30D and the video database 50 is denoted by double arrows pointing at the machine learning protocol 40 and at the video database 50. In a third instance, video database 50 is also configured to receive video information from and output video information to API 22 due to two-way communication; such two-way communication between the API 22 and the video database 50 is denoted by double arrows pointing at API 22 and at the video database 50.

As discussed in the aforementioned communication configurations, video database 50 is configured to receive information from and send information to at least one or more of the API 22, the video transcoding architecture 30, and the machine learning protocol 40. In the first instance, video database 50 may continuously receive video transcode information or data from the transcode information component 30D based on the video transcoding performed on the video stream 16 by video transcoder 30B and the formatted video stream stored in second storage component 30C.

In the second instance, video database 50 may also output video information to the machine learning protocol 40 based on information received from one or both of API 22 and the transcode information component 30D. In this instance, such video information that is sent to machine learning protocol 40 may improve and expand conduit anomaly detection capabilities of the conduit assessor 40B of machine learning protocol 40 when inspecting video streams outputted by optical imaging device 4. In this instance, such video information that is sent to machine learning protocol 40 may also improve and expand cross-bore detection capabilities of the cross-bore analyzer 40C of machine learning protocol 40 when inspecting video streams outputted by optical imaging device 4.

System 2 may also include a reporter 60. As best seen in FIG. 2, the reporter 60 is diagrammatically shown as a box labeled 60 and is operatively in communication with the UI 18. Particularly, the reporter 60 is configured to receive conduit analysis data and/or information as well as a formatted video stream from UI 18 due to one-way communication; such one-way communication between UI 18 and reporter 60 is denoted by a single arrow pointing from UI 18 to the reporter 60. In operation, reporter 60 is configured to output at least one report in any suitable, tangible format that accounts for one or more conduit anomalies detected inside of the wastewater conduit captured on the video stream 16 by optical imaging device 4.

In other embodiments, an analyst interface may be provided with system 2 or with the anomaly detection program 20 for outputting additional values that are not extracted from the videos. Such additional values that may be outputted by the analyst interface include, but are not limited to, dates of inspections, addresses of inspections, validations of a footage counter (e.g., an encoder) function during inspections, and a number of observations that may lead to obfuscation of data. It should be noted that analyst interface may be provided as a standalone function in system 2 or anomaly detection program 20 or be integrated into an aforementioned component of the system 2 (e.g., UI 18) or the anomaly detection program 20.

Having now discussed the components and features of system 2, including anomaly detection program 20, a method of using system 2 with anomaly detection program 20 for detecting one or more conduit anomalies is discussed in greater detail below.

It should be understood that such operation of anomaly detection program 20 discussed herein and illustrated in FIG. 2 is executed by the controller 10 subsequent to the recording of the video stream 16 by optical imaging device 4. As such, the architectures and protocols of anomaly detection program 20 of this embodiment, such as video transcoding architecture 30 and machine learning protocol 40, are designed to be executed by the controller 10 when previously recorded video stream 16 is loaded into the anomaly detection program 20 for autonomously detecting conduit anomalies captured in the video stream 16.

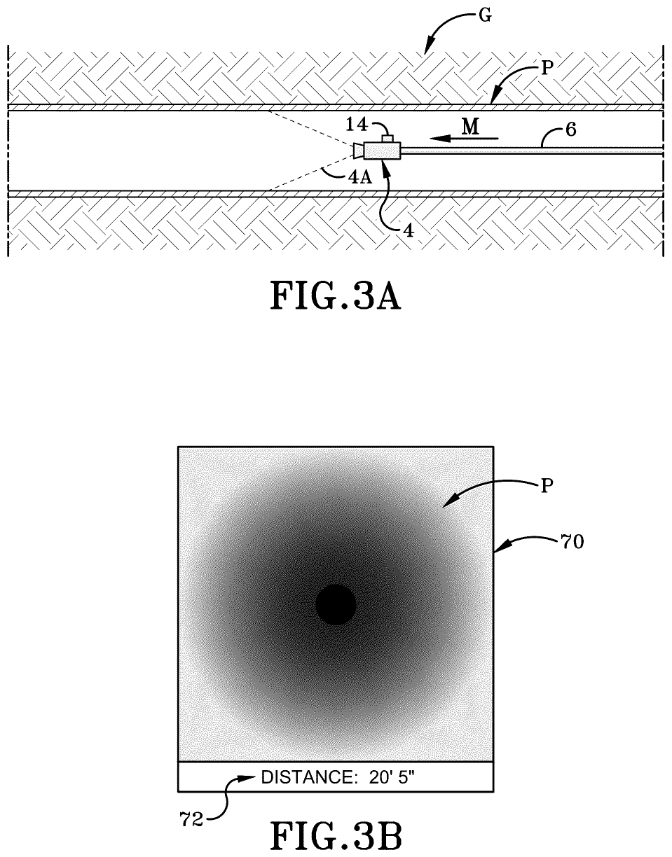

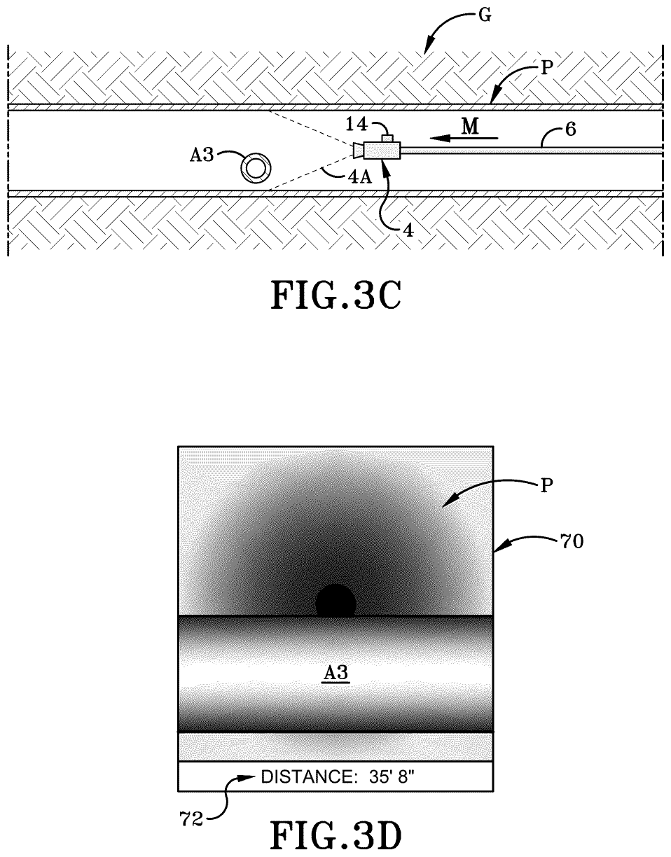

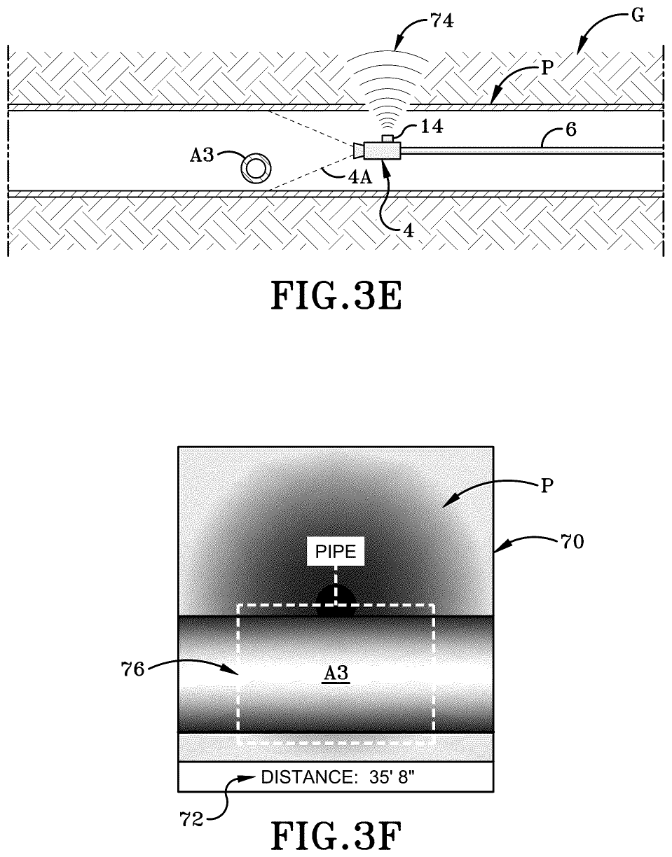

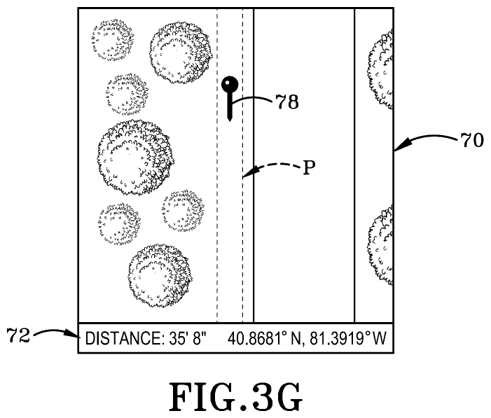

As best seen in FIGS. 1 and 3A-3B, the optical imaging device 4 is placed inside a desired and/or selected wastewater conduit for viewing the internal structure of the wastewater conduit; such wastewater conduit is generally denoted by “P” in FIGS. 1 and 3A-3G. Once inside the wastewater conduit, the optical imaging device 4 is then moved longitudinally through the wastewater conduit for a desired distance or until a conduit anomaly ceases further movement of the optical imaging device 4. It should be understood that optical imaging device 4 may be engaged with a device or tool so that an operator or user of the optical imaging device 4 may move the optical imaging device 4 to a desired distance or until a conduit anomaly ceases further movement of the optical imaging device 4.

As the optical imaging device 4 is traversing through the wastewater conduit, at least one viewing device or monitor signal emitter 14, which may operably engage with the optical imaging device 4, may also continuously output a distance reading (generally labeled 70 in FIGS. 3B, 3D, and 3F and labeled 74 in FIG. 3E). In operation, such distance reading 70 outputted by the signal emitter 14 may be overlaid on the video stream 16 by anomaly detection program 20 when viewed on a monitor or viewing screen 70. In this particular embodiment, such use of the distance reading 70 and viewing of the video stream 16 on monitor screen 70 occurs after the video stream 16 has been loaded into the anomaly detection program 20 and is formatted by the video transcoding architecture 30 and the machine learning protocol 40. It should be understood that such distance reading 70 may be calculated by a reel feed monitor or sensor (e.g., a radial encoder) that is equipped to reel 8 as the optical imaging device 4 is feed into the wastewater conduit.

Once the system 2 has traversed through a desired length inside of the wastewater conduit or traversed through the entire wastewater conduit, such video stream 16 captured and recorded by optical imaging device 4 may then be loaded into the anomaly detection program 20. To initiate the video stream 16 is loaded into the anomaly detection program 20, the video stream 16 is initially inputted into UI 18. At this point in operation, UI 18 outputs the video stream 16 to API 22 so that architectures and protocols of anomaly detection program 20, such as video transcoding architecture 30 and machine learning protocol 40, may transcode the video stream 16 to a desired format and may overlay conduit anomaly alerts and signals to the video stream 16 for generating reports of said wastewater conduit inspection.

In a first operation, API 22 outputs the video stream 16 to the video transcoding architecture 30 for transcoding the video stream 16 from the first or raw format to the second or digitized format. As best seen in FIG. 2, the first storage component 30A initial receives and stores the video stream 16 from API 22. In operation, the first storage component 30A also outputs the video stream 16 to the video transcoder 30B. In operation, the video transcoder 30B transcodes and/or formats the video stream 16 from the raw format to the digitized format at a specific bitrate or stream quality.

Once transcoded, the digitized format of the video stream 16 is then sent from the video transcoder 30B to the second storage component 30C of video transcoding architecture 30. At this point in the operation, the second storage component 30C may store the digitized format of the video stream 16 and output said digitized format to the transcode information component 30D. Such video data captured by the transcode information component 30D may then be sent to and received by the video database 50.

It should be understood that while second storage component 30C outputs the digitized format of video stream 16 to transcode information component 30D, second storage component 30C may also output the digitized format of video stream 16 to other components provided in anomaly detection program 20. In one instance, the second storage component 30C outputs the digitized format of the video stream 16 to the machine learning protocol 40 for autonomously detecting conduit anomalies inside of the wastewater conduit that were captured on the video stream 16; such operation of machine learning protocol 40 is discussed in greater detail below. In another instance, the second storage component 30C outputs the digitized format of the video stream 16 to the API 22.

Once the digitized format of the video stream 16 is received by the machine learning protocol 40, each component of the machine learning protocol 40 may operate simultaneously to autonomously detect conduit anomalies captured in the video stream 16. At this point in the operation, the video quality analyzer 40A is solely judging and/or evaluating the quality of the digitized format of the video stream 16. Such evaluation by the video quality analyzer 40A determines if the video stream 16 meets a predetermined format threshold or bitrate so that the conduit assessor 40B and/or the cross-bore analyzer 40C may autonomously detect conduit anomalies. If such evaluation of the digitized format of the video stream 16 by the video quality analyzer 40A is approved, the video stream 16 may then be analyzed by the conduit assessor 40B and the cross-bore analyzer 40C.

With respect to the conduit assessor 40B, controller 10 is configured to find any conduit anomaly (except cross-bores) upon execution of conduit assessor 40B. In the present disclosure, conduit assessor 40B is configured to assist the controller 10 in autonomously detecting one or more conduit anomalies in the wastewater conduit that were captured in the video stream 16. In one instance, conduit assessor 40B assists the controller 10 in autonomously detecting a crack or fissure (labeled “A1” in FIG. 1) found in the wastewater conduit and captured in the video stream 16. In another instance, conduit assessor 40B assists the controller 10 in autonomously detecting a root or similar vegetation (labeled “A2” in FIG. 1) found in the wastewater conduit and captured in the video stream 16. As discussed above, the conduit assessor 40B assists the controller 10 due to the conduit assessor 40B being loaded with PACP and other suitable assessment programs conventionally used in wastewater conduit and sewer inspections.

With respect to the cross-bore analyzer 40C, controller 10 is configured to specifically find cross-bores inside a wastewater conduit upon execution of conduit assessor 40B. In the present disclosure, cross-bore analyzer 40C is configured to assist the controller 10 in autonomously detecting one or more cross-bores provided in the wastewater conduit that were captured in the video stream 16. In one instance, cross-bore analyzer 40C assists the controller 10 in autonomously detecting a cross-bore (labeled “A3” in FIGS. 1 and 3C-3F) found in the wastewater conduit and captured in the video stream 16. As discussed above, the cross-bore analyzer 40C assists the controller 10 due to the cross-bore analyzer 40C be loaded with pipe assessment procedures and other suitable assessment programs conventionally used in wastewater conduit and sewer inspections.

In this particular embodiment, at least one cross-bore is autonomously detected by machine learning protocol 40 (see FIGS. 3F). Once detected, the controller 10, after executing the cross-bore analyzer 40C, will automatically record such detection of the cross-bore in a report, which is discussed in greater detail below (see FIGS. 3F). Such report may state what type of conduit anomaly was detected as well as the location of the conduit anomaly based on the geolocation that was recorded by use of the signal emitter 14 (see the geolocation pinned on a map and labeled 76 in FIG. 3G). If desired, controller 10 may also apply, with assistance from machine learning protocol 40, an alert or signal about the cross-bore on the video stream 16 when autonomously detected (see FIG. 3F). Upon such analysis, the controller 10 may then output such analysis from the machine leaning protocol 40 to the video database 50.

It should be noted that upon translating the optical imaging device 4 into and out of the wastewater conduit, the delay adjuster 40D of machine learning protocol 40 is executed to prevent inadvertent or accidental assessment of non-anomalies located in the wastewater conduit. As such, the delay adjuster 40D inputs a start time delay as the optical imaging device 4 is translated into the examined wastewater conduit. In this instance, delay adjuster 40D prevents and/or halts any assessment by the machine learning protocol 40, particularly the conduit assessor 40B and the cross-bore analyzer 40C, for a predetermined time interval as the optical imaging device 4 is translated into an examined wastewater conduit. Additionally, delay adjuster 40D then inputs the end time delay as the optical imaging device 4 is translated out of the examined wastewater conduit. In this instance, the delay adjuster 40D prevents and/or halts any assessment by the machine learning protocol 40, particularly the conduit assessor 40B and the cross-bore analyzer 400, for a predetermined time interval as the optical imaging device 4 is translated out of the examined wastewater conduit.

In the present disclosure, the video database 50 may then output all video information and data that was received from the video transcoding architecture 30 and the machine learning protocol 40 to API 22. Once received by API 22, API 22 may then output such information to the UI 18 so that the operator of system 2 may view the digitized video stream 16 and/or the conduit anomaly analysis of the digitized video stream 16. If desired, such video information and data may then be sent and outputted as a report (e.g., a PDF report) by the reporter 60 to summarize all conduit anomalies found in video stream 16.

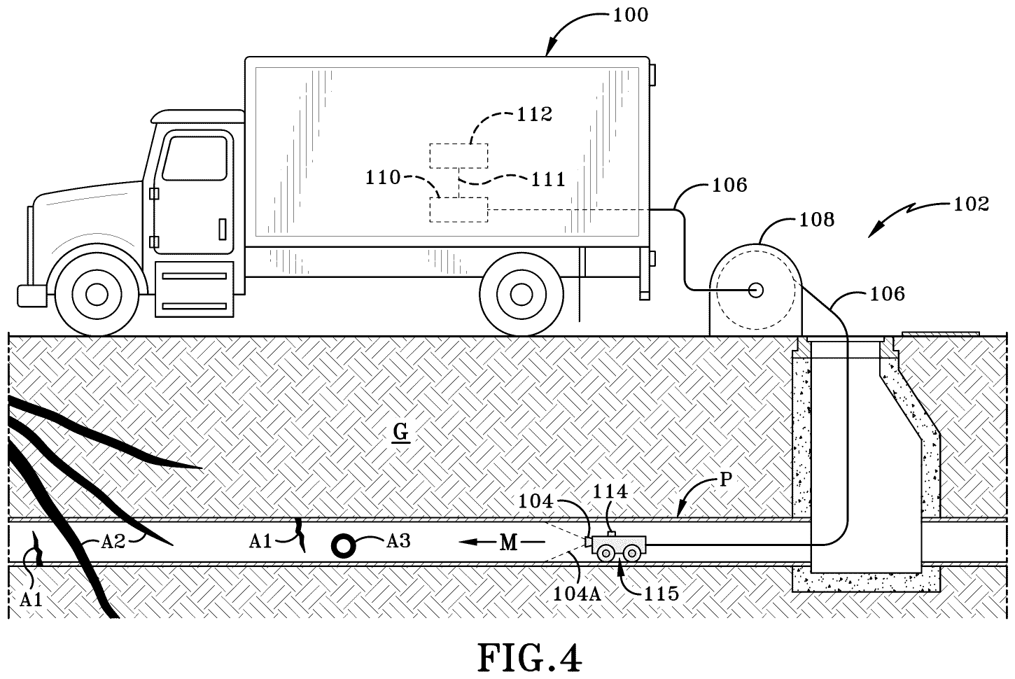

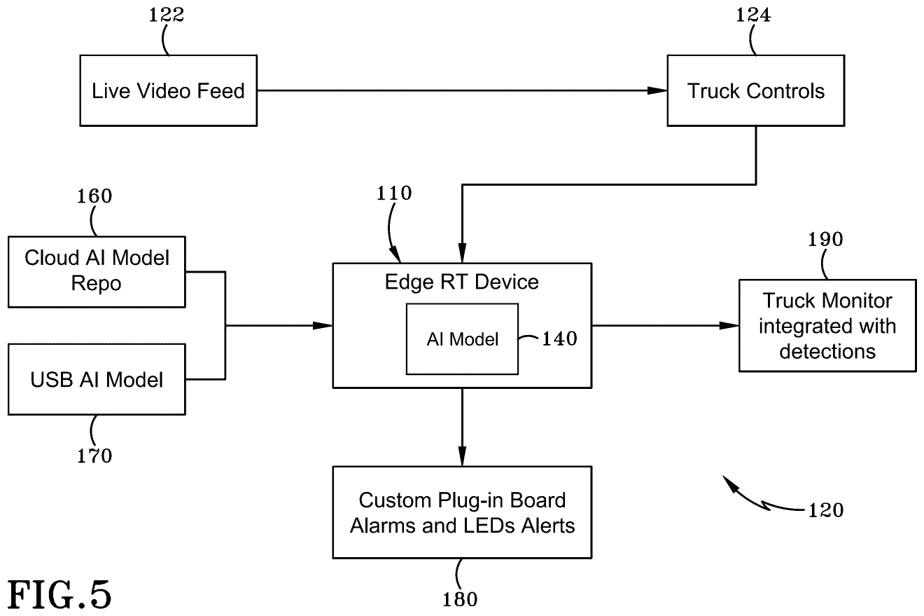

FIGS. 4-5 illustrate another control center 100 that is operatively connected with a second wastewater detection system (hereinafter “system”) 102 for detecting conduit anomalies inside of a wastewater conduit. Control center 100 and system 102 are similar to control center 1 and system 2 as discussed above and as illustrated in FIGS. 1-3G, except as detail below.

With respect to system 102, system 102 may include similar components as mentioned and provided in system 2. System 102 includes an optical imaging device 104, a cable 106 connecting the optical imaging device 104 with the control center 100, a reel 108 housing the cable 106; the optical imaging device 104, the cable 106, and the reel 108 are substantially similar to the optical imaging device 4, the cable 6, and the reel 8 of the system 2. System 2 also includes a controller 110 that is operatively in communication with the optical imaging device 104 and a computer readable medium 112 that is accessible by the controller 110; the controller 110 and the computer readable medium 112 of system 102 are substantially similar to controller 10 and the computer readable medium 12 of system 2. System 2 may optionally include a signal emitter 114 that is provided with the optical imaging device 104 and for outputting at least one location pulse to assist in geolocating the optical imaging device 104 inside of a wastewater conduit upon discovering anomalies; signal emitter 114 of system 102 is also substantially similar to signal emitter 14 of system 2.

In this embodiment, however, system 102 may include a robot or a remote-controlled vehicle generally referred to as 115 in FIG. 4. In the present disclosure, robot 115 is equipped with the optical imaging device 104 and the signal emitter 114 such that the robot 115 may be controlled to traverse through a wastewater conduit while the optical imaging device 104 records a video stream of the wastewater conduit and the signal emitter 114 outputs at least one location pulse to assist in geolocating the optical imaging device 104 and robot 115 inside of a wastewater conduit. It should be understood that cable 106 may also be connected with robot 115 to which an operator stationed in the control center 100 (or remotely through wireless means) may control the movement of the robot 115 inside of the wastewater conduit. It should also be understood that such vehicle 115 may be used in other system mentioned herein if so desired by operators or technicians of these types of systems.

In this same embodiment, system 102 includes an anomaly detection program 120 similar to anomaly detection program 20 of system 2 discussed above and illustrated in FIG. 2, except as detailed below.

Anomaly detection program 120 includes a live video stream 122 that is continuously outputted from the optical imaging device 104 in real-time. The live video stream 122 is also operatively in communication with the control center controls 124. During operation, the live video stream 122 captured by the optical imaging device 104 may be outputted and displayed on at least one monitor or viewing device of the control center controls 124 provided with control center 100. It should be understood that while control center controls 124 are stationed with the control center 100, wireless devices (e.g., smartphones, tablets, laptops, etc.) may connect with and receive the live video stream 122 from the optical imaging device 104 via suitable wireless communication systems discussed herein.

It should be understood that the anomaly detection program 120 of system 102 is diagrammatically shown in FIG. 5 and may include any components, architectures, or protocols of an anomaly detection program discussed and illustrated herein. Particularly, anomaly detection program 120 may include a user interface (UI), such as UI 18, that is operatively in communication with the live video stream 122 and the control center controls 124 to allow operators or technicians to interact with the anomaly detection program 120 when operating the system 102 and inspecting wastewater conduits with said system 102. Anomaly detection program 120 may also include an application program interface (API), such as API 22, that is operatively in communication with the live video stream 122 and the control center controls 124 to provide two or more protocols, programs, or architectures of the anomaly detection program 120 to communicate with one another. Anomaly detection program 120 may also include a video transcoding architecture, such as video transcoding architecture 30, that is operatively in communication with the live video stream 122 and the control center controls 124 for transcoding and formatting the live video stream 122 into a desired format and to view the formatted video stream on one or more devices that may be connected with control center controls 124 (wired or wireless). Anomaly detection program 120 may also include a video database, such as video database 50, that is operatively in communication with the live video stream 122 and the control center controls 124 for storing current and previous video information for improving machine learning protocols of anomaly detection program 120.

Anomaly detection program 120 also includes a machine learning protocol or artificial intelligence (A1) model 140 that is accessible by the controller 110. As best seen in FIG. 4, the machine learning protocol 140 is operatively in communication with the control center controls 124 for receiving information from control center controls 124 as well as the live video stream 122 recorded by the optical imaging device 104. Similar to machine learning protocol 40 of anomaly detection program 20, the machine learning protocol 140 is configured to continuously analyze and detect conduit anomalies observed in the live video stream 122 to include alerts and/or markers on the video stream 122 for said anomalies detected by the machine learning protocol 140. It should be understood that machine learning protocol 140 may include one or all components of machine learning protocol 40 mentioned above, including video quality analyzer 40A, conduit assessor 40B, and cross-bore analyzer 40C.

Anomaly detection program 120 may also include a cloud-based repository 160. As best seen in FIG. 4, the cloud-based repository 160 is operatively in communication with the machine learning protocol 140 such that the cloud-based repository 160 outputs information to the machine learning protocol 140 via one-way communication; such one-way communication is denoted by an arrow pointing from the cloud-based repository 160 to the machine learning protocol 140. In operation, the cloud-based repository 160 provides a pathway or gateway for managing the machine learning protocol 140; stated differently, the cloud-based repository 160 enables developers of anomaly detection program 120 to alter or modify the source code of the machine learning protocol 140. Such inclusion of the cloud-based repository 160 allows instant access to the machine learning protocol 140 on controller 110, particularly the source code of the machine learning protocol 140, without physically accessing and/or physically connecting to the controller 110.

Anomaly detection program 120 may also include a universal serial bus (USB) repository 170. As best seen in FIG. 4, USB repository 170 is operatively in communication with the machine learning protocol 140 such that the USB repository 170 outputs information to the machine learning protocol 140 via one-way communication; such one-way communication is denoted by an arrow pointing from the USB repository 170 to the machine learning protocol 140. Similar to cloud-based repository 160, the USB repository 170 provides a pathway or gateway for managing the machine learning protocol 140; stated differently, the USB repository 170 enables developers of anomaly detection program 120 to alter or modify the source code of the machine learning protocol 140. Such inclusion of the USB repository 170 allows instant access to the machine learning protocol 140 on controller 110, particularly the source code of the machine learning protocol 140, by physically accessing and/or physically connecting to the controller 110 via a USB hub on the controller 110. In other exemplary embodiments, other transportable and non-transitory computer readable medium repositories outside of the USB format are suitable for managing the machine learning protocol 140.

Anomaly detection program 120 may also include a programmable plug-in alarm and alert system 180 (hereinafter “alert system 180”). As best seen in FIG. 5, the alert system 180 is diagrammatically shown as a box labeled 180 and is operatively in communication with the machine learning protocol 140 that is accessible by controller 110. In the present disclosure, the alert system 180 is activated and/or initiated by the controller 110 upon executing the machine learning protocol 140 and detecting at least one conduit anomaly when accessing the live video stream 122. Such alerts and/or signals provided with alert system 180 may be unique and/or distinguishable based on the conduit anomaly detected by the controller 110 when executing the machine learning protocol 140.

It should be understood that such alert system 180 is fully programmable and custom to alert and/or signal a specific type of conduit anomaly detected by the controller 110 when executing the machine learning protocol 140. In one instance, a first alert or signal may be used when a fissure or crack (labeled “A1” in FIGS. 1 and 4) is detected by the controller 110 when executing the machine learning protocol 140. In another instance, a second alert or signal may be used when a root or similar vegetation (labeled “A2” in FIGS. 1 and 4) is detected by the controller 110 when executing the machine learning protocol 140; such second alert or signal may be unique and distinguishable from the first alert mentioned previously. In yet another instance, a third alert or signal may be used when a cross-bore (labeled “A3” in FIGS. 1 and 4) is detected by the controller 110 when executing the machine learning protocol 140; such third alert or signal may be unique and distinguishable from the first and second alerts mentioned previously.

System 102 also includes at least one output imaging device 190. As best seen in FIG. 5, a single output imaging device 190 is shown being operatively in communication with the controller 110. In the present disclosure, the controller 110 may output a live or real-time conduit anomaly analysis to the output imaging device 190 upon executing the machine learning protocol 140. It should be understood that the real-time conduit anomaly analysis may also be overlaid or superimposed on the real time video stream 122 as the optical imaging device 104 traverses through the wastewater conduit. In one exemplary embodiment, the output imaging device 190 may be a monitor provided with the control center 100 that is integrated with the anomaly detection program 120 and alert system 180 for displaying real-time conduit anomaly detections. It should also be understood that the alert system 180 may also be displayed on output imaging device 190 based on the type of anomaly detected by the controller 110 when executing the machine learning protocol 140.

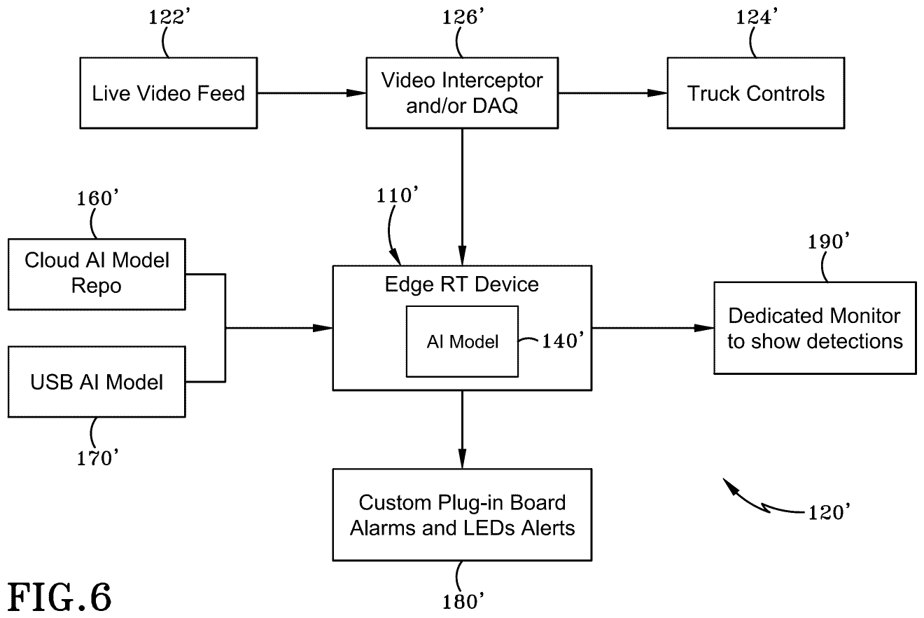

FIG. 6 illustrates an alternative anomaly detection program 120′ that is similar to anomaly detection program 120 discussed above and illustrated in FIG. 5, except as detailed below.

As best seen in FIG. 6, anomaly detection program 120′ includes a live or real-time video stream 122′, control center controls 124′, machine learning protocol 140′, cloud-based repository 160′, USB repository 170′, and alert system 180′ that are substantially similar to live or real-time video stream 122, control center controls 124, machine learning protocol 140, cloud-based repository 160, USB repository 170, and alert system 180 of anomaly detection program 120.

Similar to anomaly detection program 120, alternative anomaly detection program 120′ is diagrammatically shown in FIG. 6 and may include any components, architectures, or protocols of an anomaly detection program discussed and illustrated herein. Particularly, anomaly detection program 120′ may include a user interface (UI), such as UI 18, that is operatively in communication with the live video stream 122′ and the control center controls 124′ to allow operators or technicians to interact with the anomaly detection program 120′ when operating the system 102 and inspecting wastewater conduits with said system 102. Anomaly detection program 120′ may also include an application program interface (API), such as API 22, that is operatively in communication with the live video stream 122′ and the control center controls 124′ to provide two or more protocols, programs, or architectures of the anomaly detection program 120′ to communicate with one another. Anomaly detection program 120′ may also include a video transcoding architecture, such as video transcoding architecture 30, that is operatively in communication with the live video stream 122′ and the control center controls 124′ for transcoding and formatting the live video stream 122′ into a desired format and to view the formatted video stream on one or more devices that may be connected with control center controls 124′ (wired or wireless). Anomaly detection program 120′ may also include a video database, such as video database 50, that is operatively in communication with the live video stream 122′ and the control center controls 124′ for storing current and previous video information for improving machine learning protocols of anomaly detection program 120, which is discussed in greater detail below.

In this embodiment, however, alternative anomaly detection program 120′ includes a video interceptor or data acquisition device (hereinafter “DAQ”) 126′. As best seen in FIG. 6, DAQ 126′ is diagrammatically shown as a box labeled 126′ and is operatively in communication with the live video stream 122′, the control center controls 124′, and the machine learning protocol 140′. In the present disclosure, DAQ 126′ is configured to receive the live video stream 122′ from an optical imaging device (such as optical imaging device 104) based on one-way communication; such one-way communication is denoted by a single arrow pointing from the live video stream 122′ to DAQ 126′. DAQ 126′ is also configured to output the live video stream 122′ to the control center controls 124′ and to the machine learning protocol 140′ based on one-way communication; such one-way communication is denoted by a single arrow pointing from the DAQ 126′ to the control center controls 124′ and another single arrow pointing from the DAQ 126′ to the machine learning protocol 140′.

In operation, DAQ 126′ is configured to split and/or duplicate the live stream video 122′ based on the communication between the control center controls 124′ and the machine learning protocol 140′. In this embodiment, a first video stream is outputted to the control center controls 124′ in which the first video stream only shows raw footage from the optical imaging device 104. In this same embodiment, a second video stream is outputted to the machine learning protocol 140′ for conduit anomaly analysis in which the second video stream overlays and/or superimposes alerts and signals to the live video stream via the alert system 180′. As discussed previously, such alerts and signals only occur once the controller 110′ detects one or more conduit anomalies inside of the wastewater conduit when executing the machine learning protocol 140′. In this same embodiment, the second video stream having the alert system 180′ is outputted to an output device or monitor 190′ that is separate from the control center controls 124′. Particularly, the output imaging device 190′ is solely used to view the live stream video 122′ that includes autonomous alerts outputted by the controller 110′ upon executing machine learning protocol 140′.

It should be understood that such operation of system 102, whether using anomaly detection program 120 or alternative anomaly detection program 120′, is similar to the operation of system 2 using anomaly detection program 20, except as detail below.

With respect to FIGS. 3A-3F, such operation performed by system 102 using anomaly detection program 120 or alternative anomaly detection program 120′ is performed live or in real-time as compared to system 2 using anomaly detection program 20 with a recorded and/or logged video stream 16. In one instance, the live video feed shown in FIGS. 3A-3F illustrates live stream 122, 122′ as diagrammatically shown in anomaly detection program 120 or in alternative anomaly detection program 120′. In another instance, the live or real-time alerts and/or signals are autonomously added to the live video by the controller 110 when executing the machine learning protocol 140, 140′ and the alert system 180, 180′ (as shown in FIG. 3F). In yet another instance, the live or real-time geolocation of each conduit anomaly detected by the controller when the anomaly detection program 120 or alternative anomaly detection program 120′ is automatically mapped and/or pinned based on commands sent to the signal emitter 114 by controller 110.

Before operating system 102 with anomaly detection program 120 or alternative anomaly detection program 120′, the cloud-based repository 160, 160′ or the USB repository 170, 170′ may be utilized to update or modify source code of the machine learning protocol 140, 140′.

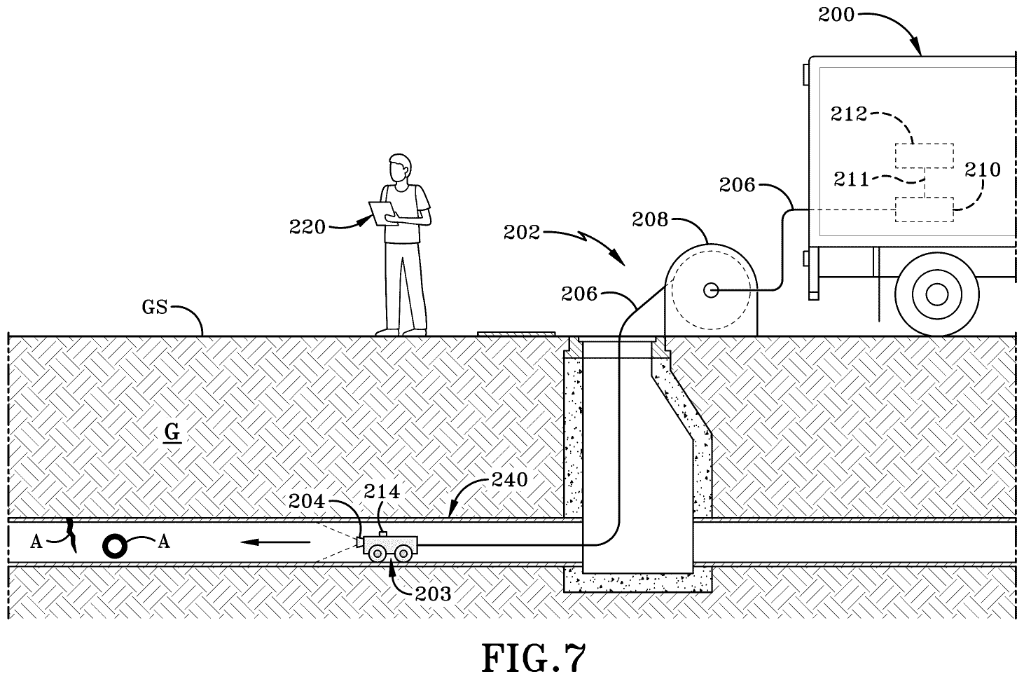

FIGS. 7-9F illustrate a control center 200 that operatively connects with a third wastewater detection system or an anomaly location system (hereinafter “system”) 200. The system 202 may include components and programs mentioned in systems discussed herein, including system 2, 102, 102′; except as detailed below.

System 202 includes a controlled inspection vehicle 203 (hereinafter “vehicle 203”) that is controlled by the control center 200. As best seen in FIG. 7, an optical imaging device 204 is provided with vehicle 203 and operatively connects with the control center 200 by a cable 206. In the present disclosure, vehicle 203 is configured to be placed into and traverse through a wastewater or sewer conduit so the optical imaging device 204 may view the inner walls and/or surfaces for conduit anomalies or irregularities; such viewing of the inner walls and/or surfaces for conduit anomalies or irregularities is discussed in greater detail below. In operation, the optical imaging device 204 records and outputs a video stream as the vehicle 203 traverses through the wastewater conduit. The optical imaging device 204 may also continuously output the video stream to the control center 200 via the cable 206 connecting the control center 200 and the vehicle 203 with one another. The system 202 may also include a reel or similar carrying device 208 for carrying and housing the cable 206 during operation.

In the present disclosure, the optical imaging device 204 is a video recording camera that is configured to record video while being located in wastewater or sewer conduits and output such video information to the control center 200 by the cable 206. It should be understood that any suitable device, commercially-available or commercially-unavailable, may be used herein for recording video while being located in wastewater or sewer conduits. It should also be understood that while the optical imaging device 204 outputs recorded video information to the control center 200 by the cable 206, any suitable electrical connection may be used to output or transfer recorded video information to a control center mentioned herein. In one exemplary embodiment, an optical imaging device mentioned herein may output or transfer recorded video information to a control center via a wireless electrical connection or system that is commercially-available or commercially-unavailable.

System 2 also includes at least one controller or processing unit 210. In the present disclosure, a single controller 210 is illustrated herein for schematic and diagrammatic purposes. In other exemplary embodiments, any suitable number of processors may be provided with a system mentioned herein for a specific inspection operation (e.g., inspecting wastewater or sewage conduits). Controller 210 is configured to logically perform protocols and/or methods that the controller 10 has access to prior to inspection operation, including detection and/or examination protocols and methods. The controller 210 may also be powered by an on-board power source and/or power supply (e.g., portable battery, etc.) in order to logically perform protocols and/or methods that are operatively in communication with the controller 210. The controller 210 may also be in logical communication with a tangible medium, such as a computer readable medium, for executing conventional guidance applications or protocols and/or novel guidance applications or protocols discussed herein.

As best seen in FIG. 7, controller 210 of system may be located with of control center 200. Still referring to FIG. 7, controller 210 is in electrical communication with the vehicle 203 and optical imaging device 204 via the cable 206. In the present disclosure, controller 210 is configured to receive and use video data outputted from the optical imaging device (e.g., raw video footage, digitized video footage, and other video data or information), via the cable 206, when executing an anomaly location program or protocol for assisting an operator when inspecting a wastewater conduit; such program is discussed in greater detail below. It should be appreciated that any suitable and/or commercially-available processor or processing unit may be used for controller 210 described and illustrated herein.

System 202 also includes a computer readable medium or media 212. As best seen in FIG. 7, system 202 includes a computer readable medium 212 that may be located with the control center 200. Referring to FIG. 7, computer readable medium 212 is in electrical communication with the controller 210 via an electrical connection 211. In the present disclosure, computer readable medium 212 is pre-loaded with an anomaly location program that is accessible and executable by the controller 10; such program is discussed in greater detail below. When the controller 210 executes the anomaly location program, the controller 210 automatically initiates communication between the controller 210 and a locator (discussed in greater detail below) when conduit anomalies or structural issues of the wastewater conduit are depicted in the video stream outputted by the optical imaging device 204. Such functions and/or steps provided in anomaly location program are discussed in greater detail below.

It should be understood that electrical connection 211 may be any suitable electrical connection or medium that provides electrical communication and/or logical communication between the controller 210 and the computer readable medium 212. In the present disclosure, electrical connection 211 is an electrical wire or cable that electrically connects the controller 210 and the computer readable medium 212 with one another so that the controller 210 may access and execute anomaly location program during a wastewater conduit inspection. In one exemplary embodiment, electrical connection 211 may be a conventional wireless connection that electrically connects the controller 210 and the computer readable medium 212 with one another so that the controller 210 may access and execute anomaly location program during a wastewater conduit inspection.

In the present disclosure, computer readable medium 212 may also be powered by an on-board power source and/or power supply (e.g., portable battery, etc.) in order to communicate with controller 210 so that controller 210 may access and execute an anomaly location program during wastewater conduit inspection; such anomaly location program is discussed in greater detail below.

System 202 also includes a transmitter 214. As best seen in FIG. 7, transmitter 214 operably engages with the vehicle 203 and is configured to be placed into and traverse through a wastewater or sewer conduit. The transmitter 214 is also operatively in communication with the controller 210 when the vehicle 203 is positioned inside of a wastewater conduit remote from the controller 10. In operation, and as discussed in greater detail below, transmitter 214 is configured to output at least one location or detection signal (in response to a command by the controller 210) when an operator or inspector of the system 202 detects and indicates at least one wastewater conduit anomaly found in the video stream outputted by the optical imaging device 204; the command instructed by controller 210 is caused by the inspector. Such inclusion of the transmitter 214 allows the system 202 to automatically map and/or plot each conduit anomaly detected in the video stream as outputted by the optical imaging device 204.

It should be understood that transmitter 214 may be configured to emit and/or transmit any suitable detection signal. In one exemplary embodiment, a transmitter mentioned herein may emit and/or transmit a radio frequency (RF) signal that include location information and/or data. In other exemplary embodiment, any suitable electrical signals may be emitted from a transmitter to transfer location data based on the position of a vehicle when traversing inside of the conduit.

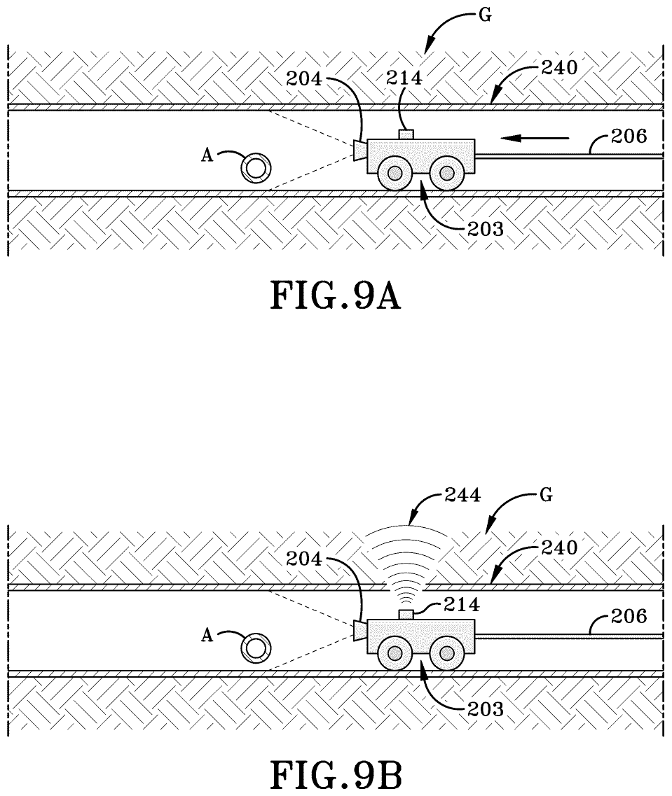

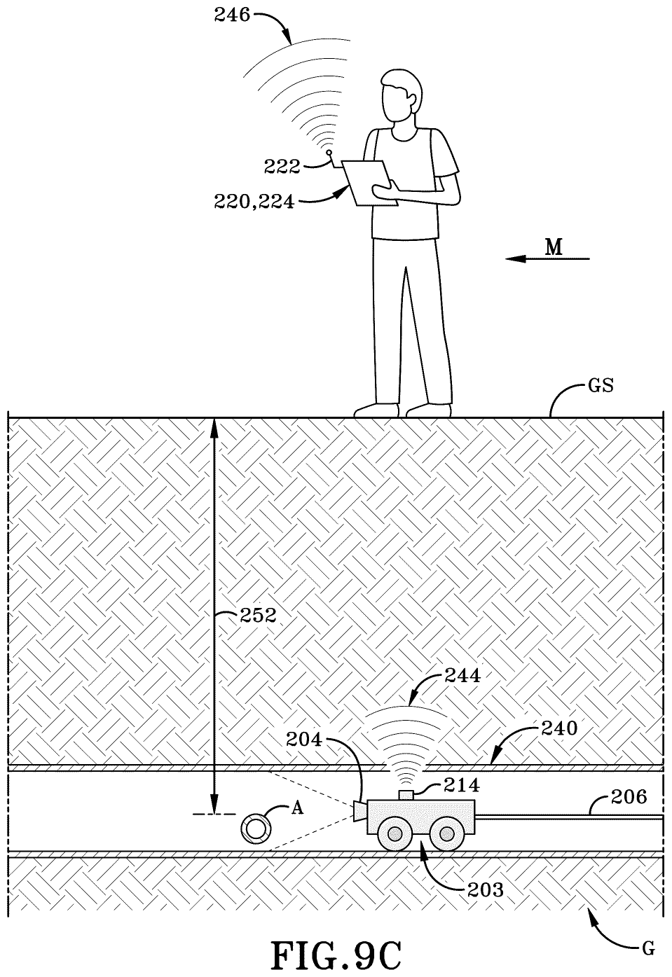

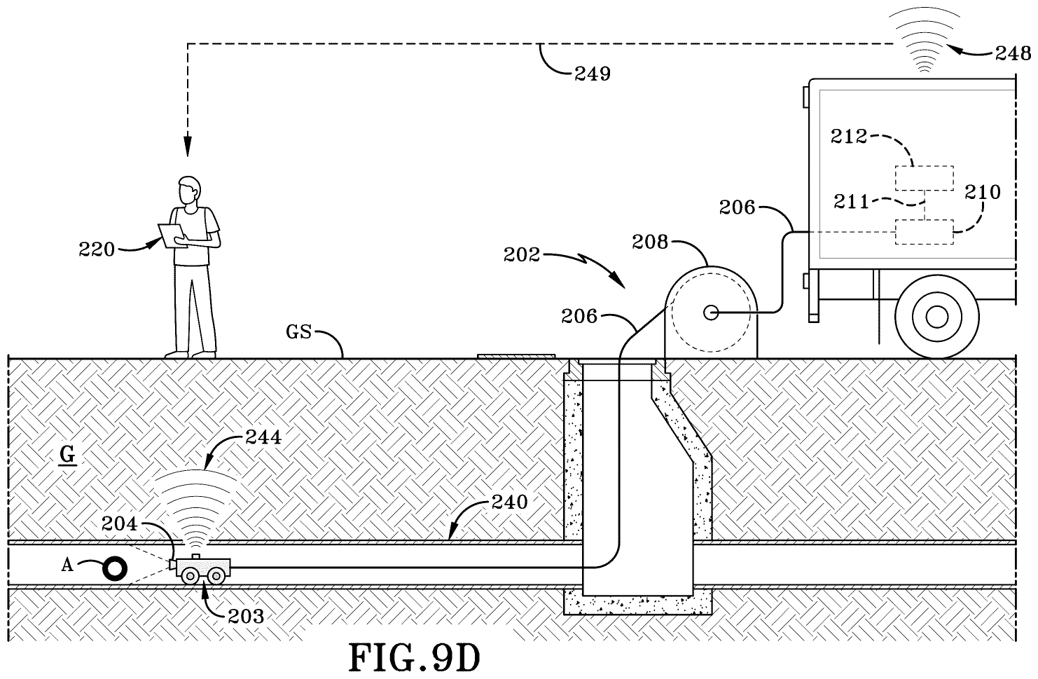

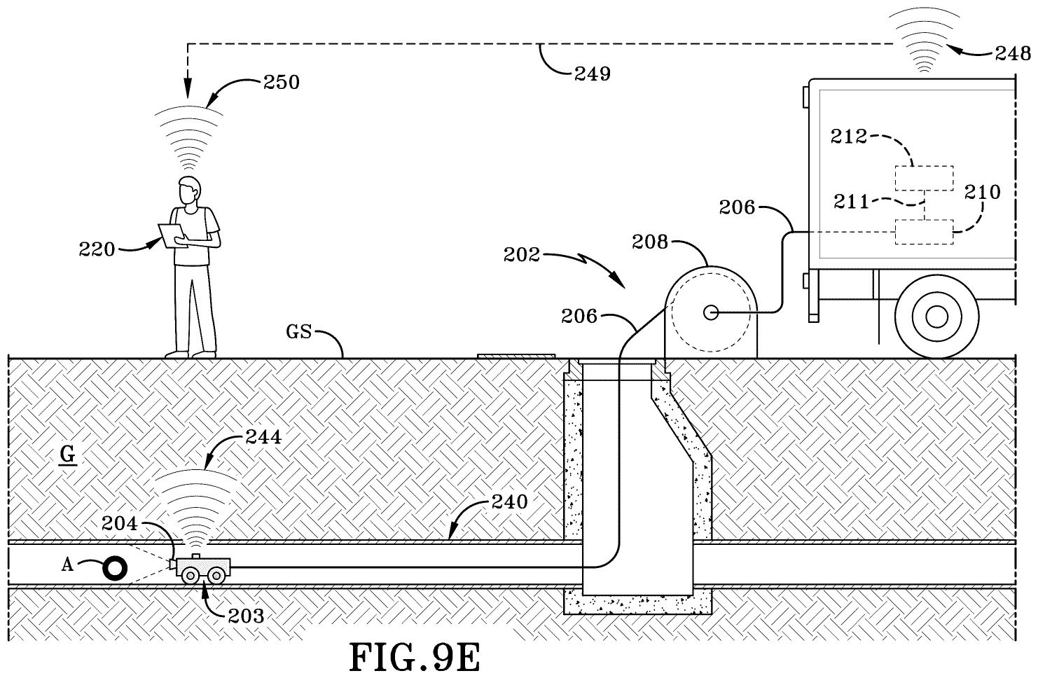

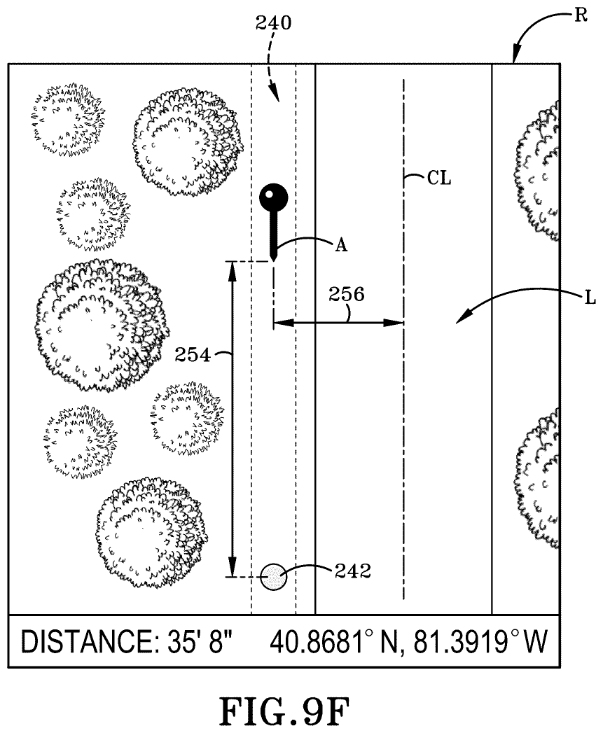

System 202 also includes a locator 220 (see FIG. 7). In the present disclosure, the locator 220 is operatively in communication with the controller 210, the computer readable medium 212, and the transmitter 214 during an anomaly detection operation (see FIGS. 9A-9F). As best seen in FIG. 7, the locator 220 includes at least one antenna or receiver 222 that is configured to communicate with the controller 210, the computer readable medium 212, and the transmitter 214 during an anomaly detection operation. The locator 220 also includes a global positioning system 224 (GPS) that is provided only on the locator 220 and is separate from the controller 210, the computer readable medium 212, and the transmitter 214.

As best seen in FIG. 7, the locator 220 is a separate device that is free from being directly connected to the controller 210, the computer readable medium 212, and/or the transmitter 214 via a wired connection. Instead, in this particular embodiment, the locator 220 is wirelessly connected to the controller 210, the computer readable medium 212, and the transmitter 214 due to the receiver 222 of the locator 220. In one instance, the locator 220 is configured to receive conduit anomaly data and/or information from the controller 210 and to output conduit anomaly data and/or information to the controller 210 via the receiver 222. In another instance, the locator 220 is configured to access programs or protocols on the computer readable medium 212 during anomaly inspections. In yet another instance, the locator 220 is also configured to search and receive conduit anomaly data and/or information from the transmitter 214 by the receiver 222. Such communication channels between the controller 210 and the locator 220 and between the transmitter 214 and locator 220 are discussed in greater detail below.

It should be understood that locator 220 may be any suitable computing device that is configured to communicate with the controller 210 and the transmitter 214 with any suitable electrical connection (either a wired connection or a wireless connection). In one exemplary embodiment, a locator mentioned herein may be a mobile electronic machine, such as a smartphone, tablet, computer, or similar mobile electronic machine, that is configured to communicate a controller mentioned herein and a transmitter of a controlled inspection vehicle mentioned herein. In another exemplary embodiment, a locator mentioned herein may be any suitable computing device, either commercially-available or commercially-unavailable at the filing date of this disclosure, that is configured to communicate with a controller mentioned herein and a transmitter of a controlled inspection vehicle mentioned herein. It should also be understood that locator 220 may also include a computer readable medium (similar to computer readable medium 212) that include anomaly location programs and/or protocols that may be accessed and utilized during anomaly inspections. It should also be understood that transmitter 214 and locator 220 may communicate with any suitable communication architecture or protocol. In one example, transmitter 214 and locator 220 communicate via radiofrequency signals to track and collect points of interest when examining and/or assessing a given wastewater conduit.

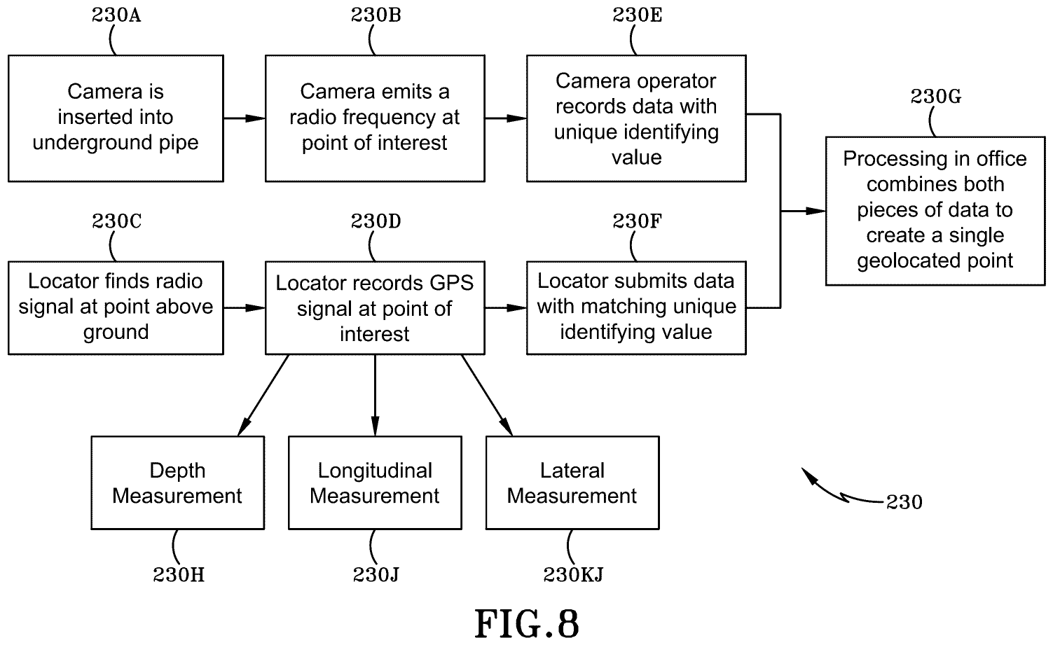

System 202 also includes an anomaly location program 230 (hereinafter “program 230”) (see FIG. 8). In the present disclosure, program 230 is stored on computer readable medium 212 and is accessible by controller 210 when an anomaly location operation is initiated. The program 230 is also accessible by the locator 220 due to the locator 220 being in operative communication with the computer readable medium 212. When the program 230 is accessed, each of the controller 210, the transmitter 214, and the locator 220 may communicate with one another to locate and map one or more anomalies found in the conduit. Such steps and/or instructions of the program 230 are discussed in greater detail below.

Program 230 includes an initial step or calibration step 230A. As best seen in FIG. 8, the calibration step 230A is diagrammatically shown as a box labeled 230A and is accessible by controller 210. In the present disclosure, calibration step 230A is accessed and executed by controller 210 when the vehicle 203 (along with optical imaging device 204 and the transmitter 214) is inserted into the conduit for inspection. At this step, controller 210 calibrates an initial or starting position of the vehicle 203 when the vehicle 203 is introduced into the conduit by the inspector of system 202. As best seen in FIG. 9F, the starting position of the vehicle 203 would be noted by controller 210 with an indicator (labeled 242 in FIG. 9F).

Program 230 also includes a second or detection emission step 230B. As best seen in FIG. 8, the detection emission step 230B is diagrammatically shown as a box labeled 230B and is accessible by controller 210 subsequent to the calibration step 230A. In the present disclosure, detection emission step 230B is accessed and executed by controller 210 in response to the inspector detecting and/or spotting at least one anomaly inside of the conduit. Upon such execution by the controller 210, the transmitter 214 is instructed to emit a continuous detection signal until the locator 220 finds the detection signal; such searching performed by locator 220 is discussed in greater detail below. For diagrammatic purposes, a detection signal or beacon emitted by the transmitter 214 is denoted by a symbol labeled 242 in FIGS. 9B-9E.

Program 230 also includes a third or searching step 230C. As best seen in FIG. 8, the searching step 230C is diagrammatically shown as a box labeled 230C and is accessible by locator 220 subsequent to the execution of calibration step 230A and concurrently with the execution of detection emission step 230B. In the present disclosure, searching step 230C is accessed and executed by locator 220 in response to the transmitter 214 emitting a continuous detection signal. Upon such execution by the locator 220, the locator 220 is instructed to continuously execute the searching step 230C until the receiver 222 finds and intercepts the detection signal emitted by the transmitter 214. As discussed in greater detail below, an operator or inspector that is operating locator 220 may traverse along the ground surface until the receiver 222 finds and intercepts the detection signal emitted by the transmitter 214 (see arrow labeled “M” in FIG. 9C). Once the detection signal is found, the searching step 230C is ceased.

Program 230 also includes a fourth or recording step of a point of interest (POI) 230D. As best seen in FIG. 8, the recording step of POI 230D is diagrammatically shown as a box labeled 230D and is accessible by locator 220 subsequent to the execution of searching step 230C. In the present disclosure, recording step of POI 230D is accessed and executed by locator 220 in response to locator 220 receiving the continuous detection signal emitted by the transmitter 214. Upon such execution by the locator 220, the locator 220 is instructed to record the detection signal at the POI that includes one or more optional measurements by the locator 220, which are discussed in greater detail below.

Program 230 also includes a fifth or recording step of operator data point 230E. As best seen in FIG. 8, the recording step of operator data point 230E is diagrammatically shown as a box labeled 230E and is accessible by the controller 210 subsequent to the detection emission step 230B (executed by controller 210) and subsequent to the searching step 230C and recording step of POI 230D (executed by locator 220). In the present disclosure, recording step of operator data point 230E is accessed and executed by controller 210 in response to the locator 220 finding and recording the detection signal emitted by the transmitter 214. Upon such execution by the controller 210, the controller 210, upon initiation by the operator of controller 210, records at least one operator or first data point of the anomaly detection that is associated with an identification code; such use of identification code with locator 220 is discussed in greater detail below. In one exemplary embodiment, the identification code used in recording step of operator data point 230E may be an alphabetical and/or numerical code having one or more digits for associating a specific anomaly detected inside of the conduit.

Program 230 also includes a sixth or recording step of locator data point 230F. As best seen in FIG. 8, the recording step of locator data point 230F is diagrammatically shown as a box labeled 230F and is accessible by the locator 220 subsequent to the searching step 230C and recording step of POI 230D (executed by locator 220) and subsequent to the recording step of operator data point 230E (executed by controller 210). In the present disclosure, recording step of locator data point 230F is accessed and executed by locator 220 in response to the controller 210 recording at least one operator data point of the anomaly detection that is associated with an identification code. Upon such execution by the locator 220, the locator 220 records at least one locator or second data point of the same anomaly recorded by the controller 210 in the recording step of operator data point 230E. Prior to recording at least one locator data point, the locator 220 receives the identification code from the controller 210 that was generated in the recording step of operator data point 230E. Once the identification code is received by locator 220, locator 220 submits this identification code upon recording at least one locator data point. Such use of the identification code provides a link or connection for the same anomaly detected and recorded by the controller 210 and locator 220 during a conduit inspection.

Program 230 also includes a seventh or processing step 230G. As best seen in FIG. 8, the processing step 230G is diagrammatically shown as a box labeled 230G and is accessible by the controller 210 and locator 220 subsequent to the execution of operator data point 230E (executed by controller 210) and the recording step of locator data point 230F (executed by locator 220). In the present disclosure, processing step 220G is the combination of the anomaly data recorded by the controller 210 and the anomaly data recorded by the locator 220. As such, the controller 210 and the locator 220 output and/or export the recorded anomaly data to a processor or processing unit included with system 202 or separate from system 202. In this step, the processing unit combines and generates a single geolocated point or position of each anomaly found in the conduit during a conduit inspection. Each geolocation or geolocated point generated in processing step 230G of program 230 may be included a tangible report that provides data and information relating to each anomaly found in a conduit.

Program 230 may also include optional steps and/or processes that output measurements for each anomaly found in the conduit. Such measurements of each anomaly may provide depths or distances for each anomaly found in the conduit that are measured relative to certain surfaces, landmarks, or other points proximate to the conduit.

In one exemplary embodiment, program 230 may include a depth measurement step 230H. In this exemplary embodiment, depth measurement step 230H may be diagrammatically shown as a box labeled 230H and is accessible by the locator 220. In the present disclosure, the depth measurement step 230H may be performed concurrently with the recording step of POI 230D by the locator 220. In this step, the depth measurement step 230H performed by the locator 220 measures the distance or depth between the ground surface (labeled “GS” in FIGS. 7 and 9C-9F) and the vehicle 203 once the locator 220 finds the detection signal emitted by the transmitter 214. Such distance or depth measured between the ground surface and the vehicle 203 provides an approximation of the depth of each anomaly detected by system 202 during a conduit inspection.

In another exemplary embodiment, program 230 may include a longitudinal measurement step 230J. In this exemplary embodiment, longitudinal measurement step 230J may be diagrammatically shown as a box labeled 230J and is accessible by the locator 220. In the present disclosure, the longitudinal measurement step 230J may be performed concurrently with the recording step of POI 230D by the locator 220. In this step, the longitudinal measurement step 230J performed by the locator 220 measures the distance between a starting point or location of the vehicle 203 (when the vehicle 203 is calibrated in the calibration step 230A and is inserted into the conduit) to the POI where the locator 220 finds the detection signal emitted by the transmitter 214. Such distance measured between the starting point of the vehicle 203 to the POI of the vehicle 203 provides an approximation of a longitudinal distance of each anomaly detected by system 202 relative to the starting point of the vehicle 203.

In another exemplary embodiment, program 230 may include a lateral measurement step 230K. In this exemplary embodiment, lateral measurement step 230K may be diagrammatically shown as a box labeled 230K and is accessible by the locator 220. In the present disclosure, the lateral measurement step 230K may be performed concurrently with the recording step of POI 230D by the locator 220. In this step, the lateral measurement step 230K performed by the locator 220 measures the distance between the vehicle 203 or POI in the conduit and a natural landmark (e.g., a tree, mound, or similar landmarks of the like) or manmade landmark (e.g., a road, building, structure, etc.) that is proximate to the conduit. Such distance measured between the vehicle 203 and a landmark provides an approximation of a lateral distance of each anomaly detected by system 202 relative to the landmark.

It should be understood that program 230 may be used for recurring conduit inspections or known properties that were previously inspected using system 202. It should also be understood that the depth measurement step 230H, the longitudinal measurement step 230J, and the lateral measurement step 230K are each measuring the a linear distance between two points of interest collected during operation of program 230 or measuring a linear distance between a point of interest and a reference point.

In one exemplary embodiment, one or more POIs found at a known location may use highly-visited or known landmarks on the property (e.g., a corner or point of a house or building) to measure the one or more POIs from that particular known landmark. In this exemplary embodiment, one or more of the optional measurement steps 230H, 230J, 230K mentioned above may be used to measure a linear depth of each POI from the known landmark, a linear longitudinal distance of each POI from the known landmark, or a linear lateral distance of each POI from the known landmark. Such use of a known landmark at recurring or known inspection properties with program 230 may decrease the amount of time needed to inspect known POIs or new POIs found in the conduit.

In another exemplary embodiment, program 230 may also be capable of averaging one or more POIs found during different inspections to define a central point of a specific POI uncovered in all inspections. In one example, a first anomaly or POI uncovered in a first inspection of a conduit and a second anomaly or POI uncovered in a second inspection of the same conduit may be averaged together to provide a central point of this specific POI uncovered in both the first and second inspections. In this particular embodiment, such averaging by program 230 is only used when one or more POIs are substantially close to one another when each anomaly was found and measured in their respective inspection.

In yet another exemplary embodiment, program 230 may be capable of using augmented reality (AR) technology to virtually view one or more anomalies or POIs when remote from the conduit. In one instance, locator 220 or similar device may be equipped with AR technology for viewing one or more anomalies or POIs when above the conduit, when below the conduit, or when spaced apart or at a distance away from the conduit that is not accessible without extensive removal of material or structure.

Having now described the system 202 that includes the anomaly location program 230, a method of locating at least one anomaly in a conduit with system 202 is discussed in greater detail below.

Upon inserting the vehicle 203 into a conduit (labeled 240 in FIGS. 9A-9F), the inspector or user of system 202 calibrates the starting point of the vehicle 203. In operation, the controller 210 would note the starting position or point of the vehicle 203 prior to the vehicle 203 being driven through the conduit 240. As best seen in FIG. 9F, the starting point of vehicle 203 is denoted by a symbol labeled 242 in FIG. 9F. Once the starting point in calibrated in program 230, the user of system 202 may drive the vehicle 203 into the conduit and begin the conduit inspection.

As the vehicle 203 is progressing through the conduit 240 (see FIG. 9A), the vehicle 203 may approach an anomaly disposed inside of the conduit 240. In the present disclosure, the anomaly is a cross-bore disposed inside of the conduit 240 and is labeled “A” in FIGS. 9A-9E. Once the user of the system 202 views the anomaly inside of the conduit 240, via the video stream outputted by the optical imaging device 204, the operator may initiate an action to emit a detection signal from the vehicle 203. As best seen in FIG. 9B, the controller 210 executes the detection emission step 230B by instructing the transmitter 214, which is located on the vehicle 203, to emit a continuous detection signal. Such detection signal emitted by the transmitter 214 is diagrammatically illustrated by a symbol labeled 244 in FIGS. 9B-9E.

Upon such emission of the detection signal by transmitter 214, another operator that is operating the locator 220 may move along a ground surface (denoted “GS” in FIG. 9C) until the locator 220 finds and receives the detection signal 244. At this point, the locator 220 accesses and executes the searching step 230C by instructing the receiver 222 to search and find the detection signal emitted by the transmitter 214. As best seen in FIG. 9C, the receiver 222 of the locator 220 finds and receives the detection signal 244 at a distance away from the vehicle 203. Once the locator 220 receives the detection signal 244, the locator 220 then accesses and executes the recording step of POI 230D to record and/or collet this specific location or POI of the anomaly disposed inside of the conduit 240. Such recording of POI in this step 230D is also diagrammatically illustrated by a symbol labeled 246 in FIGS. 9B-9E.

Upon such recording of the POI by locator 220, the controller 210 then accesses and executes the recording step of operator data point 230E. At this point, the operator viewing the video stream outputted by the optical imaging device 204 will record the data that is associated with the anomaly. Such recording of the data at this step 230E is denoted by a symbol labeled 248 in FIG. 9D. Once the data for this particular anomaly is recorded, an identification code is associated with this particular anomaly to differentiate such anomaly from other anomalies found in the conduit. In operation, and as stated above, the identification code is sent to the locator 220 to accomplish the recording step of locator data point 230F; such transmission of the identification code to the locator 220 is denoted by an arrow labeled 249 and is directed at the locator 220 in FIG. 9D.

Concurrently, the locator 220 also accesses and executes the recording step of locator data point 230F. Such recording of the data at this step 230F is denoted by a symbol labeled 250 in FIG. 9E. At this point, the user operating the locator 220 will record the data that is associated with the anomaly. The locator 220 will also enter and submit the identification code along with the data that is transmitted to the locator 220 from the controller 210.

It should be noted that during this process, optional measurement steps 230H, 230J, 230K may be accessed and executed by locator 220.

In one instance, the depth measurement step 230H may be executed by locator 220 upon recording the POI in step 230D. As best seen in FIG. 9C, the locator 220 may record and/or collect the detection signal emitted by the transmitter 214 (once the locator 220 finds such detection signal) which signifies the linear distance or depth between the ground surface (labeled “GS” in FIG. 9C) and the vehicle 203. The depth measurement collected by locator 220 is denoted by double arrows labeled 252 in FIG. 9C. Such linear distance or depth that is collected by the locator 220 is used to calculate an approximation of the depth between the ground surface and the vehicle 203 of each anomaly detected by system 202 during a conduit inspection by processes included in program 230, specifically step 230G.

In the same instance or in another instance, the longitudinal measurement step 230J may be executed by locator 220 upon recording the POI in step 230D. As best seen in FIG. 9F, the locator 220 may record and/or collect the detection signal emitted by the transmitter 214 (once the locator 220 finds such detection signal) which signifies the linear longitudinal distance between the starting point 242 of the vehicle 203 to the POI or anomaly. The longitudinal measurement collected by locator 220 is denoted by double arrows labeled 254 in FIG. 9F. Such linear longitudinal distance that is collected by the locator 220 is used to calculate an approximation of a longitudinal distance between the starting point 242 of the vehicle 203 to the POI of the vehicle 203 by processes included in program 230, specifically step 230G.

In the same instance or in another instance, the lateral measurement step 230K may be executed by locator 220 upon recording the POI in step 230D. As best seen in FIG. 9F, the locator 220 may record and/or collect the detection signal emitted by the transmitter 214 (once the locator 220 finds such detection signal) which signifies the distance between the vehicle 203 or POI when an anomaly is spotted in the conduit and a natural landmark (e.g., a tree, mound, or similar landmarks of the like) or manmade landmark (e.g., a road, building, structure, etc.) that is proximate to the conduit. In this instance, and as best seen in FIG. 9F, a central line (a dashed line labeled “CL”) of a road “L” that is adjacent to the conduit 240 may serve as a reference point for measuring the lateral distance of the anomaly. Such linear lateral distance that is collected by locator 220 is used to calculate an approximation of a lateral distance of each anomaly detected by system 202 between the vehicle 203 and a landmark provides Lastly, each operator data point recorded in step 230E and each locator data point 230F is outputted and processed by a separate processing unit or processor (as discussed above) to combine and generate geolocated data points for each anomaly. It should be understood that such data points may be provided on a tangible medium (labeled “R” in FIG. 9F) (such as a physical document or electronic document) that plots each anomaly along the length of the conduit as well as details relating to each anomaly found in the conduit.

If sensors are utilized to gather data relating to the device, assembly, or system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for A1 algorithms, encapsulating relevant information essential for the analysis. A suitable A1 model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the A1 model are refined through post-processing techniques to ensure accuracy and relevance. These refined results are then interpreted to extract meaningful insights and derive actionable conclusions. Feedback from the refined results is used to improve the A1 model iteratively. The process involves incorporating new data, adjusting the model, and enhancing the analysis based on real-world feedback and evolving requirements.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method for automatically detecting at least one anomaly inside of a conduit, comprising steps of:
moving an optical imaging device of a system inside of the conduit;
viewing at least one anomaly inside of the conduit with the optical imaging device;
outputting a video stream by the optical imaging device with the at least one anomaly to a user interface of the system;
executing an anomaly detection program, by a controller of the system, from a computer readable medium in response to the at least one anomaly being viewed by the optical imaging device, wherein the controller is caused to:
automatically detect the at least one anomaly with a machine learning protocol of the anomaly detection program; and
apply an alert to the at least one anomaly on the video stream.

2. The method of claim 1, wherein the step of executing an anomaly detection program by the controller further comprises:
outputting the video stream to an application program interface;
transcoding the video stream, by a video transcoding process of the anomaly detection program, from a first video format to a second video format; and
outputting the video stream having the second video format to the machine learning protocol.

3. The method of claim 2, wherein the step of automatically detect the at least one anomaly from the machine learning protocol further comprises:
judging the second video format of the video stream by a video quality analyzer of the machine learning protocol.

4. The method of claim 2, wherein the step of automatically detect the at least one anomaly from the machine learning protocol further comprises:
determining a type of anomaly of the at least one anomaly by a conduit assessor of the machine learning protocol;
wherein the conduit assessor is loaded with pipe, lateral, and manhole assessment coding guidelines.

5. The method of claim 2, wherein the step of automatically detect the at least one anomaly from the machine learning protocol further comprises:
determining the at least one anomaly is a cross-bore defined in the conduit by a cross-bore analyzer of the machine learning protocol.

6. The method of claim 5, wherein the step of executing the anomaly detection program by the controller further comprises:
storing the video stream having the first format in a first storage component of the video transcoding process;
transcoding the video stream from the first format to a second format by a video transcoder; and
storing the video stream having the second format in a second storage component of the video transcoding process.

7. The method of claim 6, wherein the step of executing the anomaly detection program by the controller further comprises:
outputting the video stream with the second format to a transcode information component; and
outputting the video stream to a database of the anomaly detection program.

8. The method of claim 6, wherein the step of executing the anomaly detection program by the controller further comprises:
outputting the video stream with the second format to the machine learning protocol.

9. The method of claim 7, further comprising:
outputting the database to the machine learning protocol; and
training the machine learning protocol with the database.

10. The method of claim 9, further comprising:
outputting a report of the at least one anomaly detected by the system.

11. A system for automatically detecting at least one anomaly inside of a conduit, comprising:
an optical imaging device;
a controller operatively in communication with the optical imaging device;
a global positioning system (GPS) operably engaged with the optical imaging device and is operatively in communication with the controller; and
an anomaly detection program stored on a computer readable medium that is executable by the controller;
wherein when the controller executes the anomaly detection program, the controller is instructed to automatically detect the at least one anomaly inside of the conduit and is instructed to record a location of the at least one anomaly with the GPS in response to the optical imaging device viewing the at least one anomaly inside of the conduit.

12. The system of claim 11, wherein the anomaly detection program further comprises:
an application program interface;
a video transcoding architecture operatively in communication with the application program interface; and
a machine learning protocol operatively in communication with the application program interface and the video transcoding architecture.

13. The system of claim 12, wherein the machine learning protocol comprises:
a video quality analyzer operatively in communication with the video transcoding architecture.

14. The system of claim 12, wherein the machine learning protocol further comprises:
a conduit assessor operatively in communication with the video transcoding architecture and configured with pipe, lateral, and manhole assessment coding guidelines.

15. The system of claim 12, wherein the machine learning protocol further comprises:
a cross-bore analyzer operatively in communication with the video transcoding architecture and configured with cross-bore assessment guidelines.

16. The system of claim 15, wherein the video transcoding architecture comprises:
a first storage component operatively in communication with the application program interface;
a video transcoder operatively in communication with the first storage component;
a second storage component operatively in communication with the first storage component and the machine learning protocol; and
a video transcoding service operatively in communication with the second storage component.

17. The system of claim 12, wherein the anomaly detection program further comprises:
a video database operatively in communication with the video transcoding architecture and the machine learning protocol.

18. A computer program product stored on a computer readable media and executable by a controller of a system for automatically detecting at least one anomaly inside of a conduit:
executing, by the controller, a first step to automatically detect the at least one anomaly with a machine learning protocol of an anomaly detection program in response to the at least one anomaly being viewed on a video stream outputted by an optical imaging device of the system; and
executing, by the controller, a second step to automatically apply an alert to the at least one anomaly on the video stream.

19. The computer program product of claim 18, further comprising:
executing, by the controller, a third step to output the video stream to an application program interface;
executing, by the controller, a fourth step to transcode the video stream, by a video transcoding process of the anomaly detection program, from a first video format to a second video format; and
executing, by the controller, a fifth step to output the video stream having the second video format to the machine learning protocol.

20. The computer program product of claim 19, wherein the step of executing the first step by the controller further comprises:
executing, by the controller, a third step to judge the second video format of the video stream by a video quality analyzer of the machine learning protocol;
executing, by the controller, a fourth step to determine a type of anomaly of the at least one anomaly by a conduit assessor of the machine learning protocol, wherein the conduit assessor is loaded with pipe, lateral, and manhole assessment coding guidelines; and
executing, by the controller, a fifth step to determine the at least one anomaly is a cross-bore defined in the conduit by a cross-bore analyzer of the machine learning protocol.
